(19) United States
(12) Patent Application Publication
(10) Pub. No.: US 2023/0111336 A1
(43) Pub. Date: Apr. 13, 2023

(54) HIGH VOLTAGE LITHIUM-CONTAINING ELECTROCHEMICAL CELLS AND RELATED METHODS

(71) Applicant: Sion Power Corporation, Tucson, AZ (US)

(72) Inventors: Chariclea Scordilis-Kelley, Tucson, AZ (US); Michael G. Laramie, Tucson, AZ (US); Yuriy V. Mikhaylik, Tucson, AZ (US); Zhaohui Liao, Tucson, AZ (US); Urs Schoop, Tucson, AZ (US); Tracy Earl Kelley, Tucson, AZ (US)

(73) Assignee: Sion Power Corporation, Tucson, AZ (US)

(21) Appl. No.: 17/942,469

(22) Filed: Sep. 12, 2022

Related U.S. Application Data
(60) Provisional application No. 63/243,534, filed on Sep. 13, 2021.
(60) Provisional application No. 63/243,552, filed on Sep. 13, 2021.

(51) Int. Cl. H01M 4/04; H01M 4/38; H01M 4/525

(52) U.S. Cl. CPC H01M 4/0407; H01M 4/382; H01M 4/525

(57) ABSTRACT

Electrodes and electrochemical cells that can be operated at high voltages and related methods are generally described.

### RELATED APPLICATIONS

This application claims priority under 35 U.S.C. § 119(e) to U.S. Provisional Application No. 63/243,534, filed Sep. 13, 2021, and entitled “HIGH VOLTAGE LITHIUM-CONTAINING ELECTROCHEMICAL CELLS AND RELATED METHODS” and to U.S. Provisional Application No. 63/243,552, filed Sep. 13, 2021, and entitled “HIGH VOLTAGE LITHIUM-CONTAINING ELECTROCHEMICAL CELLS INCLUDING MAGNESIUM-COMPRISING PROTECTIVE LAYERS AND RELATED METHODS,” which are each incorporated herein by reference in their entirety for all purposes.

### TECHNICAL FIELD

Electrodes and electrochemical cells that can be operated at high voltages and related methods are generally described.

### BACKGROUND

In order to meet the demand of higher energy density in devices and electronics, electrodes capable of withstanding high voltages without degradation are desired. As another consideration, when the electrode is placed within an electrochemical cell or a battery, the electrolyte should also be able withstand the high voltage without decomposition. However, many conventional electrochemical cells and batteries, such as rechargeable lithium-based batteries, contain either electrodes that are unstable at higher voltages, electrolytes that are unstable at higher voltages, or both. Accordingly, improved electrochemical cells and methods are desired.

### SUMMARY

Electrochemical cells that can be operated at high voltage and related methods are described herein. The subject matter of the present disclosure involves, in some cases, interrelated products, alternative solutions to a particular problem, and/or a plurality of different uses of one or more systems and/or articles.

In one aspect, a method of forming a protective layer on an electrode is described, the method comprising, in an electrochemical cell comprising a first electrode comprises a lithium intercalation compound having a nickel content of greater than or equal to 70 at % relative to other transition metals in the lithium intercalation compound, performing the steps of: applying one or more formation cycles to a second electrode, the one or more formation cycles comprising: charging the second electrode at a first current to a voltage of greater than or equal to 4.4 V, and discharging the second electrode at a second current to a voltage of less than 4.4 V; and forming a protective layer on at least a portion of a surface of the second electrode.

In another aspect, a method of forming a protective layer on an electrode is described, the method comprising, in an electrochemical cell comprising a first electrode, performing the steps of: applying one or more formation cycles to a second electrode, the one or more formation cycles comprising charging the second electrode at a first current to a voltage of greater than or equal to 4.4 V, and discharging the second electrode at a second current to a voltage of less than 4.4 V; and forming a protective layer on at least a portion of a surface of a second electrode, wherein the protective layer comprises a lithium compound, and wherein the protective layer has an average thickness of less than or equal to 10 μm.

In another aspect, an electrochemical cell is described, comprising a first electrode comprising a lithium intercalation compound having a nickel content of greater than or equal to 70 at % relative to other transition metals in the lithium intercalation compound, a second electrode comprising a current collector, a separator between the first electrode and the second electrode, and a source of lithium between the first electrode and the separator, wherein an average thickness of lithium between the second electrode and the separator is less than or equal to 30 μm.

In another aspect, an electrochemical cell is described comprising a first electrode comprising a lithium intercalation compound having a nickel content of greater than or equal to 70 at % relative to other transition metals in the lithium intercalation compound, a second electrode comprising a current collector, a separator between the first electrode and the second electrode, a protective layer on at least a portion of a surface of the second electrode, wherein the protective layer comprises a lithium compound, and wherein the protective layer has an average thickness of less than or equal to 10 μm.

Other advantages and novel features of the present disclosure will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a schematic cross-sectional side view of an electrochemical cell with a protective layer on a portion, but not all, of the surface of a second electrode, according to some embodiments;

FIG. 1B is a schematic cross-sectional side view of an electrochemical cell with a protective layer on a surface of a second electrode that is between a solid-electrolyte interface of the second electrode and the electrolyte, according to some embodiments;

FIG. 2A-2B schematically illustrate the application of one or more formation cycles in order to form a protective layer adjacent to the second electrode, according to some embodiments;

FIG. 3A-3C are schematic cross-sectional side vides of a process of forming a layer of lithium metal and a protective layer on a current collector, according to some embodiments;

FIG. 3D is a schematic cross-sectional side view of an electrochemical cell with a source of lithium between the first electrode and the electrolyte, according to some embodiments;

FIG. 4 shows the cycle life of several electrochemical cells fabricated with and without a magnesium-coated current collector, according to some embodiments;

FIG. 5 shows the effect of elevated temperature when used during the formation cycles, according to some embodiments;

FIG. 6 shows the effect of applying various anisotropic pressures on the cycling performance of electrochemical cells, according to some embodiments;

FIG. 7 shows cycling performance of several electrochemical cells with varying amounts of cathode active material, according to some embodiments;

FIG. 8 shows the cycling performance of cells charged at different voltages, according to some embodiments; and

FIG. 9 shows the effect of various cathode active materials on electrochemical cell performance, according to some embodiments.

### DETAILED DESCRIPTION

Lithium-based batteries that can operate at higher voltages (e.g., greater than or equal to 4.4 V) may enable a greater range of applications, for example, in electric vehicles. However, many existing lithium-based batteries such as certain lithium-ion batteries cannot exceed voltages greater than 4 V due to either degradation of the electrodes and/or the electrolyte within the battery. For instance, certain existing electrolytes for lithium-ion batteries can decompose at voltages above 4 V, and, hence, it was believed that these electrolytes within the battery were unstable at these higher voltages. In some existing lithium-ion batteries, a workaround to this problem was to connect several lower voltage lithium-ion electrochemical cells in series in order to increase the overall voltage of the battery. However, it would be beneficial to increase the operating voltage of the individual electrochemical cells within a high-voltage battery so that the overall voltage of the battery can be increased while requiring fewer individual electrochemical cells within the battery.

Given the above-described electrode and/or electrolyte instability at higher voltages, it had been believed that higher voltage lithium-ion batteries were not practical in many settings. However, it has been recognized and appreciated in the context of the present disclosure that electrodes could be fabricated to operate at higher voltages without significant loss of cycling capacity. Use of these electrodes within an electrochemical cell (e.g., a lithium-ion battery) enables the electrochemical cell to operate at higher voltages than those that had been previously expected. Advantageously, these higher voltage electrodes and electrochemical cells can maintain their cycling capacity even in a so-called lithium-free configuration in which the cathode and/or the anode is, at least initially, free of any lithium or includes less lithium than that needed for a full discharge (e.g., prior to applying one or more formation cycles to the cathode and/or anode). In such a configuration, a lithium anode can be subsequently formed from a source of lithium (e.g., lithium ions within a first electrode) without significant loss of cycling capacity of the electrodes within the electrochemical cell(s).

It has been discovered within the context of this disclosure that a first electrode (e.g., a cathode) that comprises a lithium intercalation compound with a relatively high nickel content (e.g., relative to other transition metals within the compound) may improve electrode and/or electrolyte stability compared to an electrode without such amounts of nickel, all other factors being equal. Without wishing to be bound by any particular theory, it is believed that when an electrode with a high nickel content is charged and/or discharged against a counterelectrode (e.g., a second electrode, an anode), a protective layer is formed at or between the solid-electrolyte interface (SEI) of the second electrode (e.g., on at least a portion of the surface of the second electrode), which contributes to improved cycling performance of the electrochemical cell.

In some cases, the inclusion of magnesium (e.g., magnesium metal, magnesium alloys) in or on at least a portion of a current collector of the second electrode (e.g., the anode) may also contribute to the formation of a protective layer on (at least a portion of) a surface of the second electrode. For instance, the second electrode can be or may include a current collector (e.g., a copper current collector) on which an anode active material (e.g., lithium) may be subsequently formed. Without wishing to be bound by any particular theory, it is believed that inclusion of magnesium on at least a portion of the surface of the current collector of the second electrode contributes to the formation of a protective layer adjacent to the second electrode at or proximate the solid-electrolyte interface (SEI) between the second electrode and the electrolyte within the electrochemical cell. For instance, the protective layer may be formed adjacent to the lithium layer between the current collector and an electrolyte. Advantageously, the protective layer may protect the electrode surface (or at least a portion of the electrode surface) from degradation and/or may protect the electrolyte from degradation at the surface of the electrode.

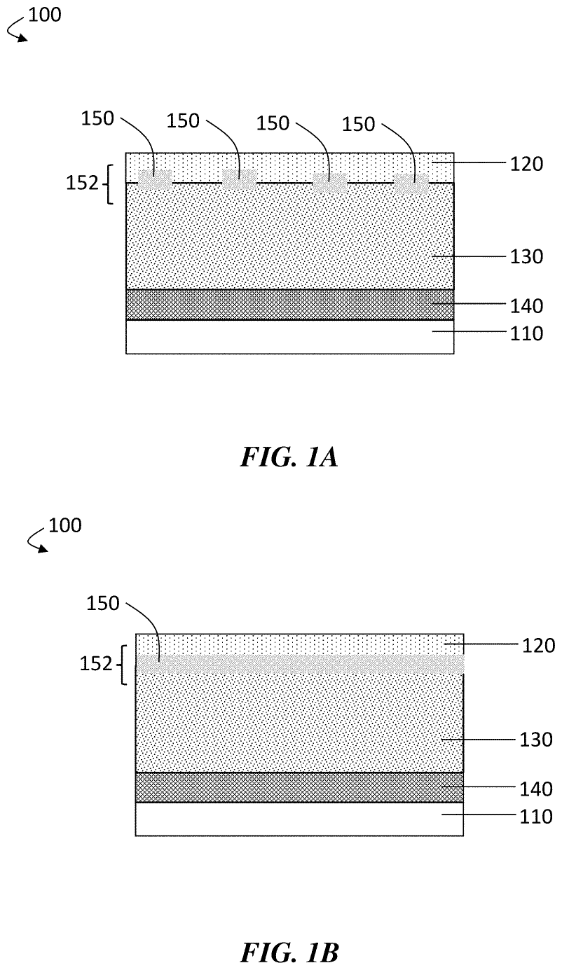

Referring to FIGS. 1A-1B the protective layer may be formed on at least a portion of the surface of an electrode (e.g., a second electrode, an anode). By way of illustration, FIG. 1A shows a schematic diagram of an electrochemical cell 100 containing a first electrode 110 adjacent to an electrolyte 130, a separator 140 adjacent to the electrolyte 130 and between the first electrode 110 and a second electrode 120. Also, in the figure, a protective layer 150 is formed on at least a portion of the second electrode 120. As mentioned above, this protective layer may prevent or inhibit the degradation of the second electrode and/or an electrolyte within the electrochemical cell. In some embodiments, the protective layer is formed at or within a SEI layer. For example, in FIG. 1B, the protective layer 150 is present within a SEI 152 between the second electrode 120 and the electrolyte 130.

FIG. 1A shows the protective layer 150 forming on at least a portion a surface of the second electrode 120, but, in some embodiments, the protective layer may form on the entirety of the surface of the second electrode 120 within the SEI 152. For example, in FIG. 1B, the protective layer 150 is formed on the surface of the second electrode 120 that is encompassed by the SEI 152. Other configurations or positions for the protective layer are possible.

In some embodiments, the protective layer comprises an inorganic compound, for example, a lithium salt or lithium compound, such as lithium oxide (Li₂O) and/or lithium carbonate (LiCO₃), as non-limiting examples. In some embodiments, the protective layer may comprise lithium fluoride (LiF).

In some embodiments, the protective layer comprises a magnesium salt or magnesium compound, such as MgO, MgCO₃, and/or MgF₂, as non-limiting examples. In some embodiments, the protective layer comprises a magnesium compound and a lithium compound. For example, the protective layer may include one or more of Li₂O, LiCO₃, and LiF in combination with one or more of MgO, MgCO₃, and MgF₂.

The protective layer may have any suitable thickness. In some embodiments, the average thickness of the protective layer is greater than or equal to 0.1 μm, greater than or equal to 0.5 μm, greater than or equal to 1 μm, greater than or equal to 2 μm, greater than or equal to 3 μm, greater than or equal to 4 μm, greater than or equal to 5 μm, greater than or equal to 6 μm, greater than or equal to 7 μm, greater than or equal to 8 μm, greater than or equal to 9 μm, or greater than or equal to 10 μm. In some embodiments, the average thickness of the protective layer is less than or equal to 10 μm, less than or equal to 9 μm, less than or equal to 8 μm, less than or equal to 7 μm, less than or equal to 6 μm, less than or equal to 5 μm, less than or equal to 4 μm, less than or equal to 3 μm, less than or equal to 2 μm, less than or equal to 1 μm, less than or equal to 0.5 μm, or less than or equal to 0.1 μm. Combinations of the above-referenced ranges as also possible (e.g., greater than or equal to 0.1 μm and less than or equal to 10 μm). Other ranges are possible. The average thickness of protective layer may be determined using scanning electron microscopy (SEM) techniques.

The protective layer may form after the application of one or more formation cycles to an electrode (e.g., a second electrode, a current collector of the second electrode). In some embodiments, the electrode (e.g., the second electrode) may initially be absent of the protective layer; however, after applying one or more formation cycles, the protective layer may form on at least a portion of a surface of the second electrode, for example, on the surface of the current collector and/or on the surface of lithium that may form on the current collector during or after the one or more formation cycles.

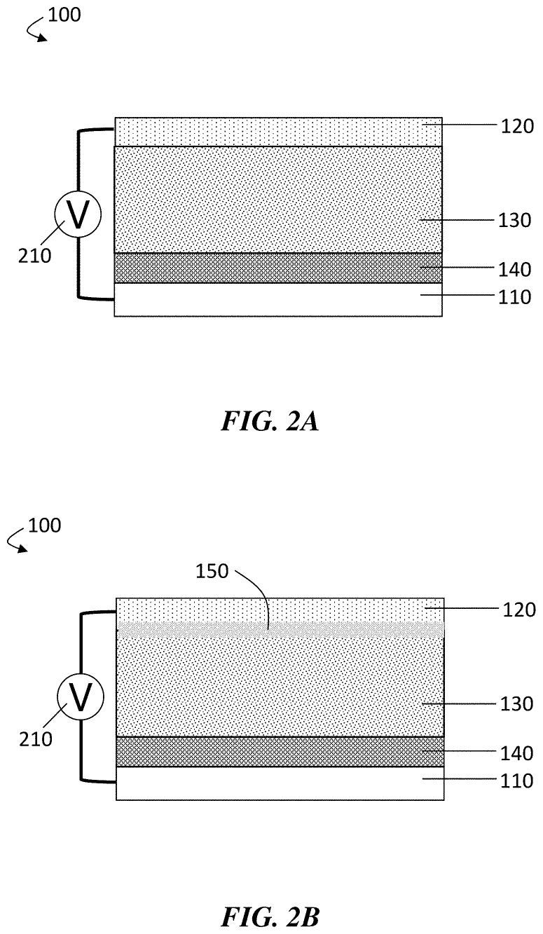

FIGS. 2A-2B schematically illustrate the formation of the protective layer on the surface of the second electrode. In FIG. 2A, a voltage source 210 is connected to the first electrode 110 and the second electrode 120 of electrochemical cell 100. Upon application of a voltage from the voltage source 210 (e.g., a voltage of greater than or equal to 4.4 V), the protective layer may form on (at least a portion) of a surface of the second electrode 120. As shown in FIG. 2B, the protective layer 150 has formed on at least a portion of the second electrode 120 after or during the application of a voltage from voltage source 210.

In some embodiments, applying the one or more formation cycles includes applying a voltage of greater than or equal to 4.4 V to the electrode. Of course, it should be understood that applying a voltage to an electrode may also include applying a voltage to a counterelectrode of the same magnitude by opposite charge. For example, in applying a voltage to a first electrode (e.g., a cathode), a voltage of the same magnitude but of opposite sign may be applied to a second electrode (e.g., an anode). In some embodiments, the formation cycles occur during the first, the second, the third, the fourth, the fifth, the sixth, the seventh, the eight, the ninth, or the tenth cycles of the electrode. That is, in some embodiments, the one or more formation cycles occurs on or within the first 10 charge/discharge cycles of the first electrode and/or the second electrode during the formation phase.

Charging (e.g., during one or more formation cycles) of an electrode (e.g., a first electrode, a second electrode) may occur at any suitable rate. As understood by those skilled in the art, charging and/or discharging may be described relative to the C-rate of the electrode, and the C-rate (C) of an electrode is a measure of the rate at which an electrode is charged and/or discharged relative to its maximum capacity. For example, a 1 C rate means that the discharge current will discharge the entire battery in 1 hour. In some embodiments, charging of an electrode occurs at a rate of greater than or equal to C/40, greater than or equal to C/20, greater than or equal to C/12, greater than or equal to C/10, greater than or equal to C/6, greater than or equal to C/3, greater than or equal to C/2, greater than or equal to 1 C, greater than or equal to 2 C, or greater than or equal to 3 C. In some embodiments, charging of an electrode occurs at a rate of less than or equal to 3 C, less than or equal to 2 C, less than or equal to 1 C, less than or equal to C/2, less than or equal to C/3, less than or equal to C/6, less than or equal to C/10, less than or equal to C/12, less than or equal to C/20, or less than or equal to C/40. Combinations of the above-referenced ranges are also possible (e.g., greater than or equal to C/40 and less than or equal to 3 C). Other ranges are possible.

Discharging an electrode may occur at any suitable rate. In some embodiments, discharging of an electrode occurs at a rate of greater than or equal to C/40, greater than or equal to C/20, greater than or equal to C/12, greater than or equal to C/10, greater than or equal to C/6, greater than or equal to C/3, greater than or equal to C/2, greater than or equal to 1 C, greater than or equal to 2 C, greater than or equal to 3 C, greater than or equal to 5 C, or greater than or equal to 10 C. In some embodiments, discharging of an electrode occurs at a rate of less than or equal to 10 C, less than or equal to 5 C, less than or equal to 3 C, less than or equal to 2 C, less than or equal to 1 C, less than or equal to C/2, less than or equal to C/3, less than or equal to C/6, less than or equal to C/10, less than or equal to C/12, less than or equal to C/20, or less than or equal to C/40. Combinations of the above-referenced ranges are also possible (e.g., greater than or equal to C/40 and less than or equal to 10 C). Other ranges are possible.

In some embodiments, charging occurs at a different rate than discharging. For example, in some embodiments, it may be advantageous to discharge an electrode at a faster rate than the rate used for charging the electrode. Conversely, in some cases, it may be advantageous to charge an electrode at a faster rate than the rate used for discharging the electrode.

In some embodiments, the one or more formation cycles may be applied before or while heating an electrode (e.g., a first electrode, a second electrode, a second electrode including a current collector). In some embodiments, an electrode is heated to a temperature of greater than or equal to 40° C., greater than or equal to 45° C., greater than or equal to 50° C., greater than or equal to 55° C., or greater than or equal to 60° C. In some embodiments, an electrode is heated to a temperature of less than or equal to 60° C., less than or equal to 55° C., less than or equal to 50° C., less than or equal to 45° C., or less than or equal to 40° C. Combinations of the above-reference ranges are also possible (e.g., greater than or equal to 40° C. and less than or equal to 60° C.). Other ranges are possible.

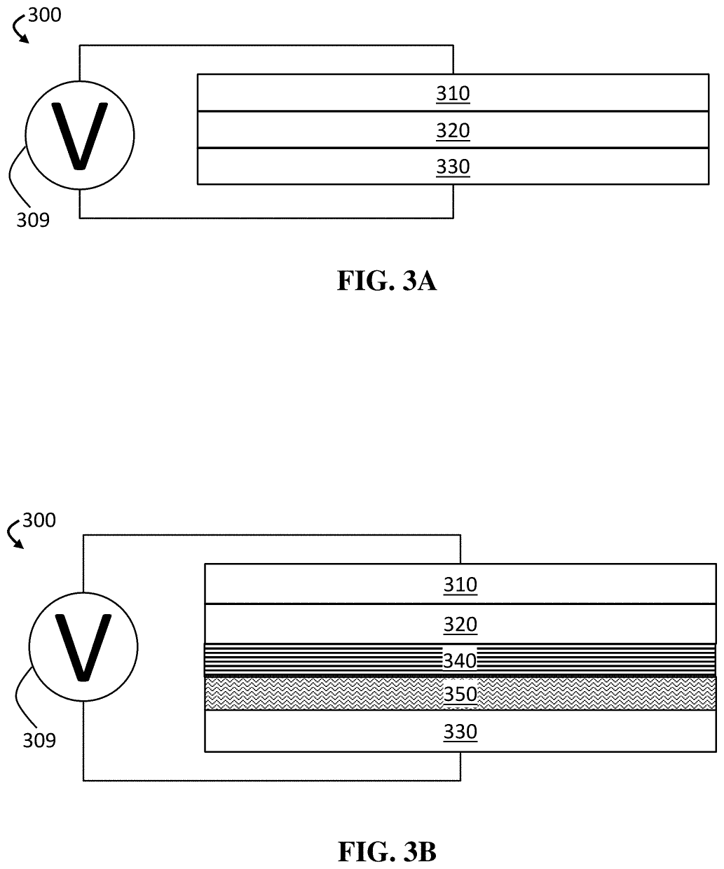

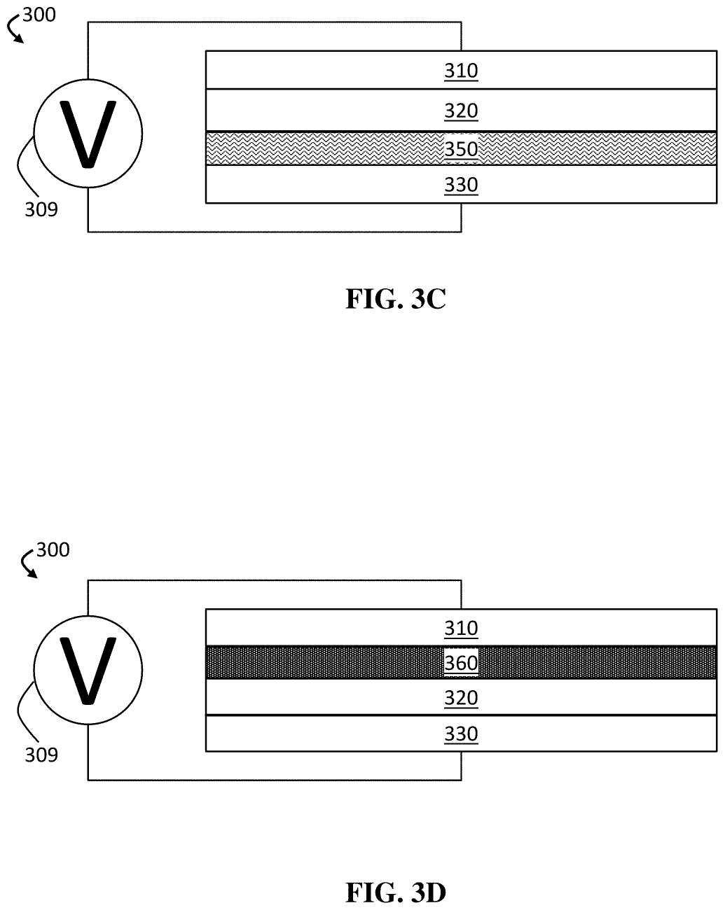

In some embodiments, an electrochemical cell may be configured such that the cell is, at least initially, free of lithium (e.g., lithium metal). In some such embodiments, an electrochemical cell may comprise a current collector which may act as an electrode (or electrode precursor) for subsequently forming a lithium anode on the surface of the current collector. By way of illustration, FIG. 3A schematically depicts a lithium free configuration of an electrochemical cell. As shown illustratively in the figures, an electrochemical cell 300 comprises a first electrode 310, which is adjacent to an electrolyte 320. A second electrode current collector 330 is initially absent of any lithium directly adjacent to it, as shown schematically in the figure. However, upon application of a voltage (e.g., from a potentiostat 309), a source of lithium such as lithium within the first electrode 310 may be oxidized while lithium ions (e.g., from electrolyte 320) may concomitantly be reduced at the current collector 330.

In some embodiments, a protective layer may form on the second current collector while the layer of lithium metal also forms on the second current collector. For example, as shown in FIG. 3B, upon application of a voltage (e.g., from the potentiostat 309), a layer of lithium metal 340 has formed on the surface of current collector 330, in addition to a protective layer 350. During one or more subsequent cycles (e.g., formation cycles, operation cycles), the lithium metal layer 340 may be depleted while the protective layer 350 remains. For example, in FIG. 3C, the electrochemical cell 300 has been cycled such that the lithium metal layer 340 has been depleted, while lithium ions have been reduced back within first electrode 310. The protective layer 350 still remains adjacent to the second electrode current collector 330 even after the layer of lithium metal 340 has been depleted.

In some embodiments, a source of lithium may be present (at least initially) between the first electrode (e.g., a cathode) and a separator and/or the electrolyte. In some embodiments, the source of lithium is within the first electrode. However, in some embodiments, the source of lithium is external the first electrode. For example, in FIG. 3D, a source of lithium 360 is between the first electrode 310 and the electrolyte 320. This source of lithium, in some embodiments, may be consumed during cycling (e.g., during one or more formation cycles). In some embodiments, the source of lithium is in the form of a layer, such as layer 360 shown in FIG. 3D. In some such embodiments, after the lithium from the source between the first electrode and the electrolyte (or separator) has been oxidized, it may subsequently be reduced at the second electrode, and upon further cycling, the layer 360 is not formed again. Instead, the lithium may intercalate or replate at the first electrode (e.g., within the first electrode).

In some embodiments, the formation process involves a sufficient number of formation cycles involving plating and depleting and replating of lithium until a lithium electrode is formed having sufficient energy density to participate in a full discharge of the cell. In some embodiments, less than or equal to 10, 8, 6, 4, or 2 formation cycles are required in order to form an electrode having sufficient energy density to participate in a full discharge of the cell. During this process, a protective layer such as protective layer 350 may also be formed as described herein.

It should be noted that while the protective layer of FIG. 3B shows the protective layer directly adjacent to the current collector, other arrangements of the protective layer are possible. For example, in some embodiments, the protective layer may be directly adjacent to the layer of lithium metal. In some embodiments, the protective layer may form a gradient along with the active material (e.g., lithium metal) on the current collector, such that the protective layer and the active material cannot be discerned. Other arrangements of the protective layer relative to a current collector are possible as this disclosure is not so limited. In some embodiments, the protective layer is formed during one or more formation cycles and lithium metal is formed on the surface of a current collector during or more formation cycles.

It should also be understood that when a portion (e.g., layer, structure, component, region) is “on”, “adjacent”, “above”, “over”, “overlying”, or “supported by” another portion, it can be directly on the portion, or an intervening portion (e.g., layer, structure, component, region) may also be present. Similarly, when a portion is “below” or “underneath” another portion, it can be directly below the portion, or an intervening portion (e.g., layer, structure, region) may also be present. A portion that is “directly adjacent”, “directly on”, “immediately adjacent”, “in contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

In some embodiments, one or more formation cycles may occur within an electrochemical cell or battery. In some embodiments, in an electrochemical cell comprising a first electrode comprising a lithium intercalation compound and/or a second electrode comprising a current collector, one or more formation cycles is applied to the first electrode and/or the second electrode. Additional details describing various electrochemical cell components are described in more detail below.

As mentioned above, various embodiments described herein may include electrodes, such as a first electrode and a second electrode. In some embodiments, the first electrode is a cathode or comprises a cathode active material and the second electrode is an anode or comprises an anode active material. However, it should be understood that electrochemical cells or batteries may have additional electrodes, such as a third electrode, a fourth electrode, a fifth electrode, and so forth, as this disclosure is not so limited. In some embodiments, multiple cathodes and/or anodes may be present, for example, as multilayer stack in which multiple electrodes are fabricated on a substrate (e.g., a flexible substrate). In some embodiments, an electrode (e.g., a second electrode) is (at least initially) free of an electrode active material (e.g., an anode active material) and may comprise or be a current collector. Additional details regarding current collectors are provided elsewhere herein.

In some embodiments, an electrode (e.g., a first electrode) is a cathode comprising a cathode active material. In an exemplary embodiment, the cathode active material comprises a nickel-cobalt-manganese (NCM) compound, which may intercalate and deintercalate lithium (e.g., lithium ions). For example, the NCM compound may be a layered oxide, such as lithium nickel manganese cobalt oxide, LiNiₓMn_{y}Co_{z}O₂. In some such embodiments, the sum of x, y, and z is 1. For example, a non-limiting example of a suitable NCM compound is LiNi_{1/3}Mn_{1/3}Co_{1/3}O₂. In some such embodiments, the NCM compounds has a relatively high nickel content (e.g., greater than or equal to 70 at %, greater than or equal to 75 at %, greater than or equal to 80 at %) relative to other transition metals in the compound. For example, in an NCM811, the relative atomic ratio of nickel, cobalt, and manganese is 8:1:1, respectively, such that the atomic percentage of nickel is 8/10, or at 80 at %. In some embodiments, the NCM compound is (at least initially) free of lithium, but lithium may intercalate into the compound during cycling (e.g., during one or more formation cycles).

While in some embodiments, the cathode active material comprises an NCM material, other cathode active materials are possible. For example, in some embodiments, the cathode active material is a lithium transition metal oxide (other than NCM) or a lithium transition metal phosphate. Non-limiting examples include LiₓCoO₂ (e.g., Li_{1.1}CoO₂), LiₓNiO₂, LiₓMnO₂, LiₓMn₂O₄ (e.g., Li_{1.05}Mn₂O₄), LiₓCoPO₄, LiₓMnPO₄, and LiCoₓNi₍₁₋ₓ₎O₂. In some such embodiments, the value of x may be greater than or equal to 0 and less than or equal to 2 and the value of y may be greater than 0 and less than or equal to 2. In some embodiments, x is typically greater than or equal to 1 and less than or equal to 2 when the electrochemical device is fully discharged, and less than 1 when the electrochemical device is fully charged. In some embodiments, a fully charged electrochemical device may have a value of x that is greater than or equal to 1 and less than or equal to 1.05, greater than or equal to 1 and less than or equal to 1.1, or greater than or equal to 1 and less than or equal to 1.2. Further examples include LiₓNiPO₄, where (0<x≤1), LiMnₓNi_{y}O₄ where (x+y=2) (e.g., LiMn_{1.5}Ni_{0.5}O₄), LiNiₓCo_{y}Al_{z}O₂ where (x+y+z=1), LiFePO₄, and combinations thereof. In some embodiments, the cathode active material within a cathode comprises lithium transition metal phosphates (e.g., LiFePO₄), which can, in some embodiments, be substituted with borates and/or silicates.

As mentioned above, in some embodiments, the cathode active material comprises a lithium intercalation compound (i.e., a compound that is capable of reversibly inserting lithium ions at lattice sites and/or interstitial sites). In some cases, the cathode active material comprises a layered oxide. A layered oxide generally refers to an oxide having a lamellar structure (e.g., a plurality of sheets, or layers, stacked upon each other). Non-limiting examples of suitable layered oxides include lithium cobalt oxide (LiCoO₂), lithium nickel oxide (LiNiO₂), and lithium manganese oxide (LiMnO₂). In some embodiments, the layered oxide is lithium nickel cobalt aluminum oxide (LiNiₓCo_{y}Al_{z}O₂, also referred to as “NCA”). In some such embodiments, the sum of x, y, and z is 1. For example, a non-limiting example of a suitable NCA compound is LiNi_{0.8}Co_{0.15}Al_{0.05}O₂. In some embodiments, the electroactive material is a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnₓFe₁₋ₓPO₄, also referred to as “LMFP”). A non-limiting example of a suitable LMFP compound is LiMn_{0.8}Fe_{0.2}PO₄. In some embodiments, the electroactive material is a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is a lithium manganese oxide with the chemical formula LiMₓMn₂₋ₓO₄ where M is one or more of Co, Mg, Cr, Ni, Fe, Ti, and Zn. In some embodiments, x may equal 0 and the spinel may be lithium manganese oxide (LiMn₂O₄, also referred to as “LMO”). Another non-limiting example is lithium manganese nickel oxide (LiNiₓMn₂₋ₓO₄, also referred to as “LMNO”). A non-limiting example of a suitable LMNO compound is LiNi_{0.5}Mn_{1.5}O₄. In some cases, the electroactive material of the second electrode comprises Li_{1.14}Mn_{0.42}Ni_{0.25}Co_{0.29}O₂ (“HC-MNC”), lithium carbonate (Li₂CO₃), lithium carbides (e.g., Li₂C₂, Li₄C, Li₆C₂, Li₈C₃, Li₆C₃, Li₄C₃, Li₄C₅), vanadium oxides (e.g., V₂O₅, V₂O₃, V₆O₁₃), and/or vanadium phosphates (e.g., lithium vanadium phosphates, such as Li₃V₂(PO₄)₃), or any combination thereof.

In some embodiments, the cathode active material (e.g., a cathode active material of the first electrode) may comprise a source of lithium. For example, the cathode active material can be a NCM compound comprising lithium ions within the compound and may be used to form a lithium anode upon charging. In some embodiments, the source of lithium (e.g., within the cathode) has a thickness of less than or equal to 30 less than or equal to 25 μm, less than or equal to 20 μm, less than or equal to 15 μm, less than or equal to 10 μm, less than or equal to 5 μm, or less than or equal to 1 In some embodiments, the source of lithium has a thickness of greater than or equal to 1 greater than or equal to 5 μm, greater than or equal to 10 μm, greater than or equal to 15 μm, greater than or equal to 20 μm, greater than or equal to 25 μm, or greater than or equal to 30 μm. Combinations of the above-referenced ranges are also possible (e.g., greater than or equal to 1 μm and less than or equal to 30 μm). Other ranges are possible.

In some embodiments, the cathode active material comprises a conversion compound. It has been recognized that a cathode comprising a conversion compound may have a relatively large specific capacity. Without wishing to be bound by a particular theory, a relatively large specific capacity may be achieved by utilizing all possible oxidation states of a compound through a conversion reaction in which more than one electron transfer takes place per transition metal (e.g., compared to 0.1-1 electron transfer in intercalation compounds). Suitable conversion compounds include, but are not limited to, transition metal oxides (e.g., Co₃O₄), transition metal hydrides, transition metal sulfides, transition metal nitrides, and transition metal fluorides (e.g., CuF₂, FeF₂, FeF₃). A transition metal generally refers to an element whose atom has a partially filled d sub-shell (e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Jr, Pt, Au, Hg, Rf, Db, Sg, Bh, Hs).

In some cases, the cathode active material may be doped with one or more dopants to alter the electrical properties (e.g., electrical conductivity) of the cathode active material. Non-limiting examples of suitable dopants include aluminum, niobium, silver, and zirconium.

In some embodiments, the cathode active material may be modified by a surface coating comprising an oxide. Non-limiting examples of surface oxide coating materials include: MgO, Al₂O₃, SiO₂, TiO₂, ZnO₂, SnO₂, and ZrO₂. In some embodiments, such coatings may prevent direct contact between the cathode active material and the electrolyte, thereby suppressing side reactions.

A cathode (e.g., a first electrode with a cathode active material deposited on a surface of a current collector) particular thickness. In some embodiments, cathode has a thickness of greater than or equal to 100 nm, greater than or equal to 250 nm, greater than or equal to 500 nm, greater than or equal to 750 nm, greater than or equal to 1 micron, greater than or equal to 2 microns, greater than or equal to 3 microns, greater than or equal to 5 microns, greater than or equal to 10 microns, greater than or equal to 20 microns, greater than or equal to 25 microns, or greater than or equal to 50 microns. In some embodiments, a cathode has a thickness of less than or equal to 50 microns, less than or equal to 25 microns, less than or equal to 20 microns, less than or equal to 10 microns, less than or equal or equal to 5 microns, less than or equal to 3 microns, less than or equal to 2 microns, less than or equal to 1 micron, less than or equal to 750 nm, less than or equal to 500 nm, less than or equal to 250 nm, or less than or equal to 100 nm. Combinations of the above-referenced ranges are also possible (e.g., greater than or equal to 100 nm and less than or equal to 10 microns). Other ranges are possible. In embodiments in which more than one cathode is present, each cathode may independently have a thickness in one or more of the ranges described above.

In some embodiments, an electrode (e.g., a second electrode) is an electrode or comprises an anode active material. A variety of suitable anode active materials are possible. In some embodiments, the anode active material comprises lithium (e.g., lithium metal), such as lithium foil, lithium deposited onto a conductive substrate (i.e., a current collector) or onto a non-conductive substrate (e.g., an adhesive layer), vacuum-deposited lithium metal, spray deposited lithium, deposited lithium, and lithium alloys (e.g., lithium-aluminum alloys and lithium-tin alloys). Lithium can be provided as one film or as several films, optionally separated. The lithium may also be a lithium alloy. Suitable lithium alloys for use in the aspects described herein can include alloys of lithium and aluminum, magnesium, silicon, indium, and/or tin. The lithium may also be provided via aerosol deposition.

In some embodiments, the lithium metal or lithium metal alloy may be present during only a portion of charge/discharge cycles. For example, the cell can be constructed without any lithium metal/lithium metal alloy on an anode current collector (e.g., copper, magnesium), and the lithium metal/lithium metal alloy may subsequently be deposited on the anode current collector during a charging or discharging step. In some embodiments, lithium may be completely depleted after discharging such that lithium is present during only a portion of the charge/discharge cycle.

For embodiments in which the anode comprises a lithium metal alloy, each of one or more alloying metals (e.g., magnesium, tin, zinc) may be present within the lithium alloy at a particular amount (with the remaining balance comprising lithium and/or some other alloying metal(s)). In some embodiments, an amount of each of one or more alloying metals of the lithium metal alloy is greater than or equal to 25 ppm, greater than or equal to 50 ppm, greater than or equal to 100 ppm, greater than or equal to 200 ppm, greater than or equal to 300 ppm, greater than or equal to 400 ppm, or greater than or equal to or 500 ppm. In some embodiments, an amount of each of one or more alloying metals of the lithium metal alloy is less than or equal to 500 ppm, less than or equal to 400 ppm, less than or equal to 300 ppm, less than or equal to 200 ppm, less than or equal to 100 pm, less than or equal to 50 ppm, or less than or equal to 25 ppm. Combinations of the above-referenced ranges are also possible. In some embodiments, an amount of each of one or more alloying metals of the lithium metal alloy is greater than or equal 0.001 wt %, greater than or equal 0.01 wt %, greater than or equal 0.1 wt %, greater than or equal 1 wt %, greater than or equal to 2 wt %, greater than or equal to 5 wt %, greater than or equal to 10 wt %, greater than or equal to 12 wt %, greater than or equal to 15 wt %, greater than or equal to 20 wt %, greater than or equal to 25 wt %, greater than or equal to 30 wt %, greater than or equal to 35 wt %, greater than or equal to 40 wt %, or greater than or equal to 45 wt %. In some embodiments, an amount of each of one or more alloying metals of the lithium metal alloy is less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 12 wt %, less than or equal to 10 wt %, less than or equal to 5 wt %, less than or equal to 2 wt %, less than or equal to 1 wt %, less than or equal to 0.1 wt %, or less than or equal to 0.001 wt %. Combinations of the above-referenced ranges are also possible (e.g., greater than or equal to 0.001 wt % and less than or equal to 10 wt %, greater than or equal to 25 ppm and less than or equal to 50 wt %). Other ranges are possible.

Suitable alloying metals for the lithium metal alloy may include, for example, a Group 1-17 element, a Group 2-14 element, or a Group 2, 10, 11, 12, 13, or 14 element. Suitable elements from Group 2 of the Periodic Table may include beryllium, magnesium, calcium, strontium, barium, and/or radium. Suitable elements from Group 10 may include, for example, nickel, palladium, and/or platinum. Suitable elements from Group 11 may include, for example, copper, silver, and/or gold. Suitable elements from Group 12 may include, for example, zinc, cadmium, and/or mercury. Suitable elements from Group 13 may include, for example, aluminum, gallium, indium, and/or thallium. Suitable elements from Group 14 may include, for example, silicon, germanium, tin, and/or lead.

In some embodiments, the anode active material (e.g., deposited on a current collector) comprises greater than or equal to 50 wt % lithium, greater than or equal to 75 wt % lithium, greater than or equal to 80 wt % lithium, greater than or equal to 90 wt % lithium, greater than or equal to 95 wt % lithium, greater than or equal to 99 wt % lithium, or more. In some embodiments, the anode active material comprises less than or equal to 99 wt % lithium, less than or equal to 95 wt % lithium, less than or equal to 90 wt % lithium, less than or equal to 80 wt % lithium, less than or equal to 75 wt % lithium, less than or equal to 50 wt % lithium, or less. Combinations of the above-reference ranges are also possible (e.g., greater than or equal to 90 wt % lithium and less than or equal to 99 wt % lithium). Other ranges are possible.

In some embodiments, an electrode (e.g., a second electrode) contains no lithium (e.g., lithium metal), at least initially (i.e., before charging/discharging). However, other embodiments may contain some lithium metal deposited on a current collector. In some such embodiments, a thickness of the lithium deposited on the current collector is greater than or equal to 0.1 micron, greater than or equal to 1 micron, greater than or equal to 3 microns, greater than or equal to 5 microns, greater than or equal to 10 microns, greater than or equal to 20 microns, or greater than or equal to 30 microns. In some such embodiments, the thickness of lithium deposited on the current collector is less than or equal to 30 microns, less than or equal to 20 microns, less than or equal to 10 microns, less than or equal to 5 microns, less than or equal to 3 microns, less than or equal to 1 micron, or less than or equal to 0.1 microns. Combinations of the above-reference ranges are also possible (e.g., greater than or equal to 0.1 microns and less than or equal to 10 microns). Other ranges are possible. In some embodiments, no lithium is present on the surface of the anode.

In some embodiments, the anode active material is a material from which lithium ions are liberated during discharge and into which the lithium ions are integrated (e.g., intercalated) during charge. In some embodiments, the anode active material comprises a lithium intercalation compound (i.e., a compound that is capable of reversibly inserting lithium ions at lattice sites and/or interstitial sites). In some embodiments, the anode active material comprises carbon. In some cases, the anode active material is or comprises a graphitic material (e.g., graphite). A graphitic material generally refers to a 2-dimensional material that comprises a plurality of layers of graphene (i.e., layers comprising carbon atoms covalently bonded in a hexagonal lattice). Adjacent graphene layers are typically attracted to each other via van der Waals forces, although covalent bonds may also be present between one or more sheets in some cases. In some cases, the carbon-comprising anode active material is or comprises coke (e.g., petroleum coke). In some embodiments, the anode active material comprises silicon, lithium, and/or any alloys of combinations thereof. In some embodiments, the anode active material comprises lithium titanate (Li₄Ti₅O₁₂, also referred to as “LTO”), tin-cobalt oxide, or any combinations thereof.

In some embodiments, an anode (e.g., a current collector, a current collector having an anode active material deposited on the surface) may be adjacent to source of lithium (e.g., lithium contained with a cathode active material of the first electrode) and/or adjacent to a separator.

An anode (e.g., a second electrode with an anode active material deposited on a surface of a current collector) particular thickness. In some embodiments, cathode has a thickness of greater than or equal to 100 nm, greater than or equal to 250 nm, greater than or equal to 500 nm, greater than or equal to 750 nm, greater than or equal to 1 micron, greater than or equal to 2 microns, greater than or equal to 3 microns, greater than or equal to 5 microns, greater than or equal to 10 microns, greater than or equal to 20 microns, greater than or equal to 25 microns, or greater than or equal to 50 microns. In some embodiments, an anode has a thickness of less than or equal to 50 microns, less than or equal to 25 microns, less than or equal to 20 microns, less than or equal to 10 microns, less than or equal or equal to 5 microns, less than or equal to 3 microns, less than or equal to 2 microns, less than or equal to 1 micron, less than or equal to 750 nm, less than or equal to 500 nm, less than or equal to 250 nm, or less than or equal to 100 nm. Combinations of the above-referenced ranges are also possible (e.g., greater than or equal to 100 nm and less than or equal to 10 microns). Other ranges are possible. In embodiments in which more than one anode is present, each anode may independently have a thickness in one or more of the ranges described above.

In some embodiments, an electrode (e.g., a first electrode, a second electrode) comprises a current collector. For example, in some embodiments, a current collector is adjacent (e.g., directly adjacent) to a cathode active material and/or an anode active material such that the current collector can remove current from and/or deliver current to the electroactive layer. It will also be understood that, for some embodiments, an electrode may (at least initially) comprise the current collect without any electrode active material (e.g., lithium), such that the electrode is the current collector for at least a portion of charging or discharging the electrode That is, in some embodiments, an electrode, such as the second electrode, is free of any lithium, or other electrode active material. In some such embodiments, upon charging and/or discharging (e.g., applying one or more formation cycles) to the electrode, an electrode active material, such as lithium metal, may form adjacent to the current collector as a part of the electrode. However, in other embodiments, an electrode comprises a current collector and an electrode active material (e.g., NCM, lithium metal).

A wide range of current collectors are known in the art. Suitable current collectors may include, for example, metals, metal foils (e.g., aluminum foil), polymer films, metallized polymer films (e.g., aluminized plastic films, such as aluminized polyester film), electrically conductive polymer films, polymer films having an electrically conductive coating, electrically conductive polymer films having an electrically conductive metal coating, and polymer films having conductive particles dispersed therein.

In some embodiments, the current collector includes one or more conductive metals such as aluminum, copper, magnesium, chromium, stainless steel and/or nickel. For example, a current collector may include a copper metal layer. Optionally, another conductive metal layer, such as magnesium or titanium, may be positioned on the copper layer. For example, as mentioned above, in some embodiments, a current collector (e.g., a copper current collector) has magnesium deposited on at least a portion of a surface of the current collector. Other current collectors may include, for example, expanded metals, metal mesh, metal grids, expanded metal grids, metal wool, woven carbon fabric, woven carbon mesh, non-woven carbon mesh, and carbon felt. Furthermore, a current collector may be electrochemically inactive. In other embodiments, however, a current collector may comprise an electroactive material or have an electrode active material deposited on a surface of the current collector.

For embodiments comprising a current collector, the current collector may comprise an alloy (e.g., magnesium, tin, zinc) and each metal of this alloy may be present at a particular amount (with the remaining balance comprising some other alloying metal(s) of the current collector). In some embodiments, an amount of each of one or more alloying metals of the current collector is greater than or equal to 25 ppm, greater than or equal to 50 ppm, greater than or equal to 100 ppm, greater than or equal to 200 ppm, greater than or equal to 300 ppm, greater than or equal to 400 ppm, or greater than or equal to or 500 ppm. In some embodiments, an amount of each of one or more alloying metals of the current collector is less than or equal to 500 ppm, less than or equal to 400 ppm, less than or equal to 300 ppm, less than or equal to 200 ppm, less than or equal to 100 pm, less than or equal to 50 ppm, or less than or equal to 25 ppm. Combinations of the above-referenced ranges are also possible. In some embodiments, an amount of each of one or more alloying metals of the current collector is greater than or equal 0.001 wt %, greater than or equal 0.01 wt %, greater than or equal 0.1 wt %, greater than or equal 1 wt %, greater than or equal to 2 wt %, greater than or equal to 5 wt %, greater than or equal to 10 wt %, greater than or equal to 12 wt %, greater than or equal to 15 wt %, greater than or equal to 20 wt %, greater than or equal to 25 wt %, greater than or equal to 30 wt %, greater than or equal to 35 wt %, greater than or equal to 40 wt %, or greater than or equal to 45 wt %. In some embodiments, an amount of each of one or more alloying metals of the current collector is less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 12 wt %, less than or equal to 10 wt %, less than or equal to 5 wt %, less than or equal to 2 wt %, less than or equal to 1 wt %, less than or equal to 0.1 wt %, or less than or equal to 0.001 wt %. Combinations of the above-referenced ranges are also possible (e.g., greater than or equal to 0.001 wt % and less than or equal to 10 wt %, greater than or equal to 25 ppm and less than or equal to 50 wt %). Other ranges are possible.

Suitable alloying metals for the material of the current collector may include, for example, a Group 1-17 element, a Group 2-14 element, or a Group 2, 10, 11, 12, 13, or 14 element. Suitable elements from Group 2 of the Periodic Table may include beryllium, magnesium, calcium, strontium, barium, and/or radium. Suitable elements from Group 10 may include, for example, nickel, palladium, and/or platinum. Suitable elements from Group 11 may include, for example, copper, silver, and/or gold. Suitable elements from Group 12 may include, for example, zinc, cadmium, and/or mercury. Suitable elements from Group 13 may include, for example, aluminum, gallium, indium, and/or thallium. Suitable elements from Group 14 may include, for example, silicon, germanium, tin, and/or lead.

As described above, in some embodiments, a current may be present without an electrode active material (e.g., a cathode active material, an anode active material) present on a surface of the current collector during at least a portion of a formation cycle of the electrode and/or during at least a portion of a charge/discharge cycle. In such an embodiment, the current collector may act as an electrode precursor in which, during formation and/or during subsequent charge/discharge cycles, an electrode active material (e.g., an anode active material such as lithium) may be formed (or deposited) on at least a portion of a surface of the current collector.

A current collector may have any suitable thickness. For instance, the thickness of a current collector may be greater than or equal to 0.1 microns, greater than or equal to 0.3 microns, greater than or equal to 0.5 microns, greater than or equal to 1 micron, greater than or equal to 3 microns, greater than or equal to 5 microns, greater than or equal to 7 microns, greater than or equal to 9 microns, greater than or equal to 10 microns, greater than or equal to 12 microns, greater than or equal to 15 microns, greater than or equal to 20 microns, greater than or equal to 25 microns, greater than or equal to 30 microns, greater than or equal to 40 microns, or greater than or equal to 50 microns. In some embodiments, the thickness of the current collector may be less than or equal to 50 microns, less than or equal to 40 microns, less than or equal to 30 microns, less than or equal to 25 microns, less than or equal to 20 microns, less than or equal to 15 microns, less than or equal to 12 microns, less than or equal to 10 microns, less than or equal to 9 microns, less than or equal to 7 microns, less than or equal to 5 microns, less than or equal to 3 microns, less than or equal to 1 micron, less than or equal to 0.5 microns, less than or equal to 0.3 microns, or less than or equal to 0.1 microns. Combinations of the above-referenced ranges are also possible (e.g., greater than or equal to 0.3 microns and less than or equal to 15 microns). Other ranges are possible.

In some embodiments, an electrochemical cell or battery may comprise a separator (e.g., adjacent to a cathode, adjacent to an anode, adjacent to a source of lithium, adjacent to a current collector of an electrode). The separator material may be a non-electronically and/or a non-ionically conductive material that prevents the cathode and the anode from undesired shorting, for example, due to the formation of metallic dendrites from layer to another layer. That is, the separator may be configured to inhibit (e.g., prevent) physical contact between layers (e.g., between a cathode layer and an anode layer), which could result in short circuiting of the electrochemical cell. In some embodiments, separator can be configured to be substantially electronically non-conductive, which can inhibit the degree to which the separator causes short circuiting of the electrochemical cell. In some embodiments, all or portions of the separator can be formed of a material with a bulk electronic resistivity of at least about 10⁴, at least 10⁵, at least 10¹⁰, at least 10¹⁵, or at least 10²⁰ Ohm meters. Bulk electronic resistivity may be measured at room temperature (e.g., 25° C.).

In some embodiments, the separator can be ionically conductive, while in other embodiments, the separator is substantially ionically non-conductive. In some embodiments, the average ionic conductivity of the separator is greater than or equal to 10⁻⁷ S/cm, greater than or equal to 10⁻⁶ S/cm, greater than or equal to 10⁻⁵ S/cm, greater than or equal to 10⁻⁴ S/cm, greater than or equal to 10⁻² S/cm, or greater than or equal to 10-1 S/cm. In some embodiments, the average ionic conductivity of the separator may be less than or equal to 1 S/cm, less than or equal to 10⁻¹ S/cm, less than or equal to 10⁻² S/cm, less than or equal to 10⁻³ S/cm, less than or equal to 10⁻⁴ S/cm, less than or equal to 10⁻⁵ S/cm, less than or equal to 10⁻⁶ S/cm, less than or equal to 10⁻⁷ S/cm, or less than or equal to 10⁻⁸ S/cm. Combinations of the above-referenced ranges are also possible (e.g., an average ionic conductivity of greater than or equal to 10⁻⁸ S/cm and less than or equal to about 10⁻¹ S/cm).

In some embodiments, the separator is a solid. The separator may be porous to allow an electrolyte solvent (i.e., a liquid electrolyte) to pass through it. However, in some cases, the separator does not substantially include a solvent (like in a gel), except for solvent that may pass through or reside in the pores of the separator. In other aspects, a separator may be in the form of a gel.

A separator as described herein can be made of a variety of materials. The separator may be or comprises a polymeric material in some instances, or be formed of an inorganic material (e.g., glass fiber filter papers) in other instances. Examples of suitable separator materials include, but are not limited to, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(∈-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some aspects, the polymer may be selected from poly(n-pentene-2), polypropylene, polytetrafluoroethylene, polyamides (e.g., polyamide (Nylon), poly(∈-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK), and combinations thereof.

The mechanical and electronic properties (e.g., conductivity, resistivity) of these polymers are known. Accordingly, those of ordinary skill in the art can choose suitable materials based on their mechanical and/or electronic properties (e.g., ionic and/or electronic conductivity/resistivity), and/or can modify such polymers to be ionically conducting (e.g., conductive towards single ions) based on knowledge in the art, in combination with the description herein. For example, the polymer materials listed above and herein may further comprise salts, for example, lithium salts (e.g., LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, and LiN(SO₂CF₃)₂), to enhance ionic conductivity, if desired.

Those of ordinary skill in the art, given the present disclosure, would be capable of selecting appropriate materials for use as the separator or separator material. Relevant factors that might be considered when making such selections include the ionic conductivity of the separator material; the ability to deposit or otherwise form the separator material on or with other materials in the electrochemical cell; the flexibility of the separator material; the porosity of the separator material (e.g., overall porosity, average pore size, pore size distribution, and/or tortuosity); the compatibility of the separator material with the fabrication process used to form the electrochemical cell; the compatibility of the separator material with the electrolyte of the electrochemical cell; and/or the ability to adhere the separator material to the ion conductor material. In some embodiments, the separator material can be selected based on its ability to survive the aerosol deposition processes without mechanically failing. For example, in aspects in which relatively high velocities are used to deposit the plurality of particles (e.g., inorganic particles), the separator material can be selected or configured to withstand such deposition.

A separator (e.g., a separator comprising a separator material) may have any suitable porosity. In some embodiments, the separator has a porosity greater than or equal to 20%, greater than or equal to 25%, greater than or equal to 30%, greater than or equal to 40%, or greater than or equal to 50%. In some embodiments, the porosity of the separator is less than or equal to 70%, less than or equal to 60%, less than or equal to 50%, less than or equal to 40%, less than or equal to 30%, less than or equal 25%, or less than or equal to 20%. Combinations of the above-referenced ranges are also possible (e.g., greater than or equal to 20% and less than or equal to 40%). Other ranges are possible.

A separator may have any suitable thickness. In some embodiments, the separator has a thickness of greater than or equal to 100 nm, greater than or equal to 250 nm, greater than or equal to 500 nm, greater than or equal to 750 nm, greater than or equal to 1 micron, greater than or equal to 2 microns, greater than or equal to 3 microns, greater than or equal to 5 microns, greater than or equal to 10 microns, greater than or equal to 20 microns, greater than or equal to 25 microns, or greater than or equal to 50 microns. In some embodiments, a separator has a thickness of less than or equal to 50 microns, less than or equal to 25 microns, less than or equal to 20 microns, less than or equal to 10 microns, less than or equal or equal to 5 microns, less than or equal to 3 microns, less than or equal to 2 microns, less than or equal to 1 micron, less than or equal to 750 nm, less than or equal to 500 nm, less than or equal to 250 nm, or less than or equal to 100 nm. Combinations of the above-referenced ranges are also possible (e.g., greater than or equal to 100 nm and less than or equal to 10 microns). Other ranges are possible

Various embodiments described herein may include an electrolyte. In some embodiments, the electrolyte is a liquid electrolyte within the electrochemical cell. As understood by those skilled in the art, a liquid electrolyte comprises a solvent and one or more ions (e.g., lithium ions). Suitable electrolytes include organic electrolytes (i.e., an electrolyte comprising an organic solvent), gel polymer electrolytes, and solid polymer electrolytes, without limitation. The solvent may be an aqueous solvent or a non-aqueous solvent. Examples of useful non-aqueous solvents (i.e., non-aqueous liquid electrolyte solvents) include, but are not limited to, N-methyl acetamide, acetonitrile, acetals, ketals, esters (e.g., esters of carbonic acid, sulfonic acid, an/or phosphoric acid), carbonates (e.g., dimethyl carbonate, diethyl carbonate, ethyl methyl carbonate, propylene carbonate, ethylene carbonate, fluoroethylene carbonate, difluoroethylene carbonate), sulfones, sulfites, sulfolanes, suflonimidies (e.g., bis(trifluoromethane)sulfonimide lithium salt), ethers (e.g., aliphatic ethers, acyclic ethers, cyclic ethers), glymes, polyethers, phosphate esters (e.g., hexafluorophosphate), siloxanes, dioxolanes, N-alkylpyrrolidones (e.g., N-methyl-2-pyrrolidone), nitrate containing compounds, substituted forms of the foregoing, and blends thereof. Examples of acyclic ethers that may be used include, but are not limited to, diethyl ether, dipropyl ether, dibutyl ether, dimethoxymethane, trimethoxymethane, 1,2-dimethoxyethane, diethoxyethane, 1,2-dimethoxypropane, and 1,3-dimethoxypropane. Examples of cyclic ethers that may be used include, but are not limited to, tetrahydrofuran, tetrahydropyran, 2-methyltetrahydrofuran, 1,4-dioxane, 1,3-dioxolane, and trioxane. Examples of polyethers that may be used include, but are not limited to, diethylene glycol dimethyl ether (diglyme), triethylene glycol dimethyl ether (triglyme), tetraethylene glycol dimethyl ether (tetraglyme), higher glymes, ethylene glycol divinyl ether, diethylene glycol divinyl ether, triethylene glycol divinyl ether, dipropylene glycol dimethyl ether, and butylene glycol ethers. Examples of sulfones that may be used include, but are not limited to, sulfolane, 3-methyl sulfolane, and 3-sulfolene. Fluorinated derivatives of the foregoing are also useful as liquid electrolyte solvents. These electrolytes may optionally include one or more ionic electrolyte salts (e.g., to provide or enhance ionic conductivity).

In some cases, mixtures of the solvents described herein may also be used. For example, in some embodiments, mixtures of solvents are selected from the group consisting of 1,3-dioxolane and dimethoxyethane, 1,3-dioxolane and diethyleneglycol dimethyl ether, 1,3-dioxolane and triethyleneglycol dimethyl ether, and 1,3-dioxolane and sulfolane. In some embodiments, the mixture of solvents comprises dimethyl carbonate and ethylene carbonate. In some embodiments, the mixture of solvents comprises ethylene carbonate and ethyl methyl carbonate. The weight ratio of the two solvents in the mixtures may range, in some cases, from about 5 wt %:95 wt % to 95 wt %:5 wt %. For example, in some embodiments the electrolyte comprises a 50 wt %:50 wt % mixture of dimethyl carbonate:ethylene carbonate. In some other embodiments, the electrolyte comprises a 30 wt %:70 wt % mixture of ethylene carbonate:ethyl methyl carbonate. An electrolyte may comprise a mixture of dimethyl carbonate:ethylene carbonate with a ratio of dimethyl carbonate:ethylene carbonate that is less than or equal to 50 wt %:50 wt % and greater than or equal to 30 wt %:70 wt %.

In some embodiments, an electrolyte may comprise a mixture of fluoroethylene carbonate and dimethyl carbonate. A weight ratio of fluoroethylene carbonate to dimethyl carbonate may be 20 wt %:80 wt % or 25 wt %:75 wt %. A weight ratio of fluoroethylene carbonate to dimethyl carbonate may be greater than or equal to 20 wt %:80 wt % and less than or equal to 25 wt %:75 wt %.

As mentioned above, in some cases, aqueous solvents can be used with electrolytes, for example, in lithium cells. Aqueous solvents can include water, which can comprise other components such as ionic salts. As noted above, in some embodiments, the electrolyte can include species such as lithium hydroxide, or other species rendering the electrolyte basic, so as to reduce the concentration of hydrogen ions in the electrolyte.

Liquid electrolyte solvents can also be useful as plasticizers for gel polymer electrolytes, i.e., electrolytes comprising one or more polymers forming a semi-solid network. Examples of useful gel polymer electrolytes include, but are not limited to, those comprising one or more polymers selected from the group consisting of polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, polyethylene glycol diacrylates, polyethylene glycol dimethacrylates, polysulfones, polyethersulfones, derivatives of the foregoing, copolymers of the foregoing, crosslinked and network structures of the foregoing, and blends of the foregoing, and optionally, one or more plasticizers. In some embodiments, a gel polymer electrolyte comprises between 10-20%, between 20-40%, between 60-70%, between 70-80%, between 80-90%, or between 90-95% of a heterogeneous electrolyte by volume.

In some embodiments, one or more gel and/or solid polymers can be used to form the electrolyte. Examples of useful solid polymer electrolytes include, but are not limited to, those comprising one or more polymers selected from the group consisting of polyethers, polyethylene oxides, polypropylene oxides, polyimides, polyphosphazenes, polyacrylonitriles, polysiloxanes, derivatives of the foregoing, copolymers of the foregoing, crosslinked and network structures of the foregoing, and blends of the foregoing.

In addition to electrolyte solvents, gelling agents, and polymers as known in the art for forming electrolytes, the electrolyte may further comprise one or more ionic electrolyte salts, also as known in the art, to increase the ionic conductivity.

An electroactive species may be present with the electrolyte as an ionic electrolyte salt. Examples of ionic electrolyte salts for use in the electrolyte of the electrochemical cells described herein include, but are not limited to, LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂, and lithium bis(fluorosulfonyl)imide (LiFSI). Other electrolyte salts that may be useful include lithium polysulfides (Li₂Sₓ), and lithium salts of organic polysulfides (LiSₓR)ₙ, where x is an integer from 1 to 20, n is an integer from 1 to 3, and R is an organic group, and those disclosed in U.S. Pat. No. 5,538,812 to Lee et al., which is incorporated herein by reference in its entirety for all purposes.

In some embodiments, the electrolyte comprises one or more room temperature ionic liquids. The room temperature ionic liquid, if present, typically comprises one or more cations and one or more anions. Non-limiting examples of suitable cations include lithium cations and/or one or more quaternary ammonium cations such as imidazolium, pyrrolidinium, pyridinium, tetraalkylammonium, pyrazolium, piperidinium, pyridazinium, pyrimidinium, pyrazinium, oxazolium, and trizolium cations. Non-limiting examples of suitable anions include trifluromethylsulfonate (CF₃SO₃⁻), bis (fluorosulfonyl)imide (N(FSO₂)₂⁻, bis (trifluoromethyl sulfonyl)imide ((CF₃SO₂)₂N⁻, bis (perfluoroethylsulfonyl)imide((CF₃CF₂SO₂)₂N⁻ and tris(trifluoromethylsulfonyl)methide ((CF₃SO₂)₃C⁻. Non-limiting examples of suitable ionic liquids include N-methyl-N-propylpyrrolidinium/bis(fluorosulfonyl) imide and 1,2-dimethyl propylimidazolium/bis(trifluoromethanesulfonyl)imide. In some embodiments, the electrolyte comprises both a room temperature ionic liquid and a lithium salt. In some other embodiments, the electrolyte comprises a room temperature ionic liquid and does not include a lithium salt.

When present, a lithium salt may be present in the electrolyte at a variety of suitable concentrations. In some embodiments, the lithium salt is present in the electrolyte at a concentration of greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, greater than or equal to 2 M, or greater than or equal to 5 M. The lithium salt may be present in the electrolyte at a concentration of less than or equal to 10 M, less than or equal to 5 M, less than or equal to 2 M, less than or equal to 1 M, less than or equal to 0.5 M, less than or equal to 0.2 M, less than or equal to 0.1 M, less than or equal to 0.05 M, or less than or equal to 0.02 M. Combinations of the above-referenced ranges are also possible (e.g., greater than or equal to 0.01 M and less than or equal to 10 M, or greater than or equal to 0.01 M and less than or equal to 5 M). Other ranges are also possible.

In some embodiments, an electrolyte comprises fluoroethylene carbonate. In some embodiments, the total weight of the fluoroethylene carbonate in the electrolyte may be less than or equal to 30 wt %, less than or equal to 28 wt %, less than or equal to 25 wt %, less than or equal to 22 wt %, less than or equal to 20 wt %, less than or equal to 18 wt %, less than or equal to 15 wt %, less than or equal to 12 wt %, less than or equal to 10 wt %, less than or equal to 8 wt %, less than or equal to 6 wt %, less than or equal to 5 wt %, less than or equal to 4 wt %, less than or equal to 3 wt %, less than or equal to 2 wt %, or less than or equal to 1 wt % versus the total weight of the electrolyte. In some embodiments, the total weight of the fluoroethylene carbonate in the electrolyte is greater than 0.2 wt %, greater than 0.5 wt %, greater than 1 wt %, greater than 2 wt %, greater than 3 wt %, greater than 4 wt %, greater than 6 wt %, greater than 8 wt %, greater than 10 wt %, greater than 15 wt %, greater than 18 wt %, greater than 20 wt %, greater than 22 wt %, greater than 25 wt %, or greater than 28 wt % versus the total weight of the electrolyte. Combinations of the above-referenced ranges are also possible (e.g., less than or equal to 0.2 wt % and greater than 30 wt %, less than or equal to 15 wt % and greater than 20 wt %, or less than or equal to 20 wt % and greater than 25 wt %). Other ranges are also possible.

In some embodiments, an electrolyte may comprise several species together that are particularly beneficial in combination. For instance, in some embodiments, the electrolyte comprises fluoroethylene carbonate, dimethyl carbonate, and/or LiPF₆. In some such embodiments, the weight ratio of fluoroethylene carbonate to dimethyl carbonate may be between 20 wt %:80 wt % and 25 wt %:75 wt % and the concentration of LiPF₆ in the electrolyte may be approximately 1 M (e.g., between 0.05 M and 2 M). The electrolyte may further comprise lithium bis(oxalato)borate (e.g., at a concentration between 0.1 wt % and 6 wt %, between 0.5 wt % and 6 wt %, or between 1 wt % and 6 wt % in the electrolyte), and/or lithium tris(oxalato)phosphate (e.g., at a concentration between 1 wt % and 6 wt % in the electrolyte).

As mentioned above, in some embodiments, the electrolyte is a solid electrolyte. In some such embodiments, the solid electrolyte may function as a separator, separating the first electrode and the second electrode (e.g., a cathode and an anode) such that solid electrolyte (e.g., a solid electrolyte material of the solid electrolyte) can facilitate the transport of ions (e.g., lithium ions) between the first electrode and the second electrode while also being electronically non-conductive to prevent short circuiting. However, it should be understood that, for some embodiments, a battery or a cell may additionally or alternatively comprise a liquid electrolyte. Details regarding liquid electrolytes are described above and elsewhere herein.

In some embodiments, the solid electrolyte comprises a ceramic material (e.g., particles of a ceramic material). Non-limiting examples of suitable ceramic materials include oxides (e.g., aluminum oxide, silicon oxide, lithium oxide), nitrides, and/or oxynitrides of aluminum, silicon, zinc, tin, vanadium, zirconium, magnesium, indium, and alloys thereof, LiₓMP_{y}S_{z} (where x, y, and z are each integers, e.g., integers less than 32, less than or equal to 24, less than or equal 16, less than or equal to 8; and/or greater than or equal to 8, greater than or equal to 16, greater than or equal to 24); and where M=Sn, Ge, or Si) such as Li₂₂SiP₂S₁₈, Li₂₄MP₂S₁₉, or LiMP₂S₁₂ (e.g., where M=Sn, Ge, Si) and LiSiPS, garnets, crystalline or glass sulfides, phosphates, perovskites, anti-perovskites, other ion conductive inorganic materials and mixtures thereof. LiₓMP_{y}S_{z} particles can be formed, for example, using raw components Li₂S, SiS₂ and P₂S₅ (or alternatively Li₂S, Si, S and P₂S₅), for example. In some embodiments, the solid electrolyte comprises a lithium ion-conducting ceramic compound. In an exemplary embodiment, the ceramic material is Li₂₄SiP₂S₁₉. In another exemplary embodiment, the ceramic material is Li₂₂SiP₂S₁₈.

In some embodiments, the ceramic material may comprise a material including one or more of lithium nitrides, lithium nitrates (e.g., LiNO₃), lithium silicates, lithium borates (e.g., lithium bis(oxalate)borate, lithium difluoro(oxalate)borate), lithium aluminates, lithium oxalates, lithium phosphates (e.g., LiPO₃, Li₃PO₄), lithium phosphorus oxynitrides, lithium silicosulfides, lithium germanosulfides, lithium oxides (e.g., Li₂O, LiO, LiO₂, LiRO₂, where R is a rare earth metal), lithium fluorides (e.g., LIF, LiBF₄, LiAlF₄, LiPF₆, LiAsF₆, LiSbF₆, Li₂SiF₆, LiSO₃F, LiN(SO₂F)₂, LiN(SO₂CF₃)₂), lithium lanthanum oxides, lithium titanium oxides, lithium borosulfides, lithium aluminosulfides, and lithium phosphosulfides, oxy-sulfides (e.g., lithium oxy-sulfides) and combinations thereof. In some embodiments, the plurality of particles may comprise Al₂O₃, ZrO₂, SiO₂, CeO₂, and/or Al₂TiO₅ (e.g., alone or in combination with one or more of the above materials). In a particular aspect, the plurality of particles may comprise Li—Al—Ti—PO₄ (LATP). The selection of the material (e.g., ceramic) will be dependent on a number of factors including, but not limited to, the properties of the layer and adjacent layers, for example, used in an electrochemical cell.

In some embodiments, an electrolyte is in the form of a layer having a particular thickness. An electrolyte layer may have a thickness of, for example, greater than or equal to 1 micron, greater than or equal to 5 microns, greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 70 microns, greater than or equal to 100 microns, greater than or equal to 200 microns, greater than or equal to 500 microns, or greater than or equal to 1 mm. In some embodiments, the thickness of the electrolyte layer is less than or equal to 1 mm, less than or equal to 500 microns, less than or equal to 200 microns, less than or equal to 100 microns, less than or equal to 70 microns, less than or equal to 50 microns, less than or equal to 40 microns, less than or equal to 30 microns, less than or equal to 20 microns, less than or equal to 10 microns, or less than or equal to 5 microns. Combinations of the above-referenced ranges are also possible (e.g., greater than or equal to 1 micron and less than or equal to 1 mm). Other ranges are possible.

Electrochemical cells described herein may be operated under an applied anisotropic force. As understood in the art, an “anisotropic force” is a force that is not equal in all directions. In some embodiments, the electrodes or the electrochemical cells described herein can be configured to withstand an applied anisotropic force (e.g., a force applied to enhance the morphology or performance of an electrode within the cell) while maintaining their structural integrity. In some embodiments, the electrodes or electrochemical cells are adapted and arranged such that, during at least one period of time during charge and/or discharge of the cell, an anisotropic force with a component normal to the active surface of a layer within the electrochemical cell is applied to the cell.

In some such cases, the anisotropic force comprises a component normal to an active surface of an electrode (e.g., a first electrode, a second electrode) within an electrochemical cell. As used herein, the term “active surface” is used to describe a surface of an electrode at which electrochemical reactions may take place. A force with a “component normal” to a surface is given its ordinary meaning as would be understood by those of ordinary skill in the art and includes, for example, a force which at least in part exerts itself in a direction substantially perpendicular to the surface. For example, in the case of a horizontal table with an object resting on the table and affected only by gravity, the object exerts a force essentially completely normal to the surface of the table. If the object is also urged laterally across the horizontal table surface, then it exerts a force on the table which, while not completely perpendicular to the horizontal surface, includes a component normal to the table surface. Those of ordinary skill will understand other examples of these terms, especially as applied within the description of this disclosure. In the case of a curved surface (for example, a concave surface or a convex surface), the component of the anisotropic force that is normal to an active surface of an electrode may correspond to the component normal to a plane that is tangent to the curved surface at the point at which the anisotropic force is applied. The anisotropic force may be applied, in some cases, at one or more pre-determined locations, in some cases distributed over the active surface of an electrode or layer. In some embodiments, the anisotropic force is applied uniformly over the active surface of a layer.

Any of the electrochemical cell properties and/or performance metrics described herein may be achieved, alone or in combination with each other, while an anisotropic force is applied to the electrochemical cell (e.g., during charge and/or discharge of the cell). In some embodiments, the anisotropic force applied to a layer or to the electrochemical cell (e.g., during at least one period of time during charge and/or discharge of the cell) can include a component normal to an active surface of a layer.

In some embodiments, the component of the anisotropic force that is normal to an active surface of a layer or an electrode defines a pressure of greater than or equal to 1 kgf/cm², greater than or equal to 2 kgf/cm², greater than or equal to 4 kgf/cm², greater than or equal to 6 kgf/cm², greater than or equal to 7.5 kgf/cm², greater than or equal to 8 kgf/cm², greater than or equal to 10 kgf/cm², greater than or equal to 12 kgf/cm², greater than or equal to 14 kgf/cm², greater than or equal to 16 kgf/cm², greater than or equal to 18 kgf/cm², greater than or equal to 20 kgf/cm², greater than or equal to 22 kgf/cm², greater than or equal to 24 kgf/cm², greater than or equal to 26 kgf/cm², greater than or equal to 28 kgf/cm², greater than or equal to 30 kgf/cm², greater than or equal to 32 kgf/cm², greater than or equal to 34 kgf/cm², greater than or equal to 36 kgf/cm², greater than or equal to 38 kgf/cm², greater than or equal to 40 kgf/cm², greater than or equal to 42 kgf/cm², greater than or equal to 44 kgf/cm², greater than or equal to 46 kgf/cm², greater than or equal to 48 kgf/cm², or more. In some embodiments, the component of the anisotropic force normal to the active surface may, for example, define a pressure of less than or equal to 50 kgf/cm², less than or equal to 48 kgf/cm², less than or equal to 46 kgf/cm², less than or equal to 44 kgf/cm², less than or equal to 42 kgf/cm², less than or equal to 40 kgf/cm², less than or equal to 38 kgf/cm², less than or equal to 36 kgf/cm², less than or equal to 34 kgf/cm², less than or equal to 32 kgf/cm², less than or equal to 30 kgf/cm², less than or equal to 28 kgf/cm², less than or equal to 26 kgf/cm², less than or equal to 24 kgf/cm², less than or equal to 22 kgf/cm², less than or equal to 20 kgf/cm², less than or equal to 18 kgf/cm², less than or equal to 16 kgf/cm², less than or equal to 14 kgf/cm², less than or equal to 12 kgf/cm², less than or equal to 10 kgf/cm², less than or equal to 8 kgf/cm², less than or equal to 6 kgf/cm², less than or equal to 4 kgf/cm², less than or equal to 2 kgf/cm², or less. Combinations of the above-referenced ranges are also possible (e.g., greater than or equal to 1 kgf/cm² and less than or equal to 50 kgf/cm²). Other ranges are possible.

The anisotropic forces applied during at least a portion of charge and/or discharge may be applied using any method known in the art. In some embodiments, the force may be applied using compression springs. Forces may be applied using other elements (either inside or outside a containment structure) including, but not limited to Belleville washers, machine screws, pneumatic devices, and/or weights, among others. In some cases, cells may be pre-compressed before they are inserted into containment structures, and, upon being inserted to the containment structure, they may expand to produce a net force on the cell. Suitable methods for applying such forces are described in detail, for example, in U.S. Pat. No. 9,105,938, which is incorporated herein by reference in its entirety.

The electrodes described herein can be part of an electrochemical cell that is integrated into a battery (e.g., a rechargeable battery). In some embodiments, the electrochemical cells (comprising one or more or the electrodes described herein) can be used to provide power to an electric vehicle or otherwise be incorporated into an electric vehicle. As a non-limiting example, electrochemical cells described herein can, in some cases, be used to provide power to a drive train of an electric vehicle. The vehicle may be any suitable vehicle, adapted for travel on land, sea, and/or air. For example, the vehicle may be an automobile, truck, motorcycle, boat, helicopter, airplane, and/or any other suitable type of vehicle.

The following applications are incorporated herein by reference, in their entirety, for all purposes: U.S. Publication No. US-2007-0221265-A1 published on Sep. 27, 2007, filed as U.S. application Ser. No. 11/400,781 on Apr. 6, 2006, and entitled “RECHARGEABLE LITHIUM/WATER, LITHIUM/AIR BATTERIES”; U.S. Publication No. US-2009-0035646-A1, published on Feb. 5, 2009, filed as U.S. application Ser. No. 11/888,339 on Jul. 31, 2007, and entitled “SWELLING INHIBITION IN BATTERIES”; U.S. Publication No. US-2010-0129699-A1 published on May 17, 2010, filed as U.S. application Ser. No. 12/312,764 on Feb. 2, 2010; patented as U.S. Pat. No. 8,617,748 on Dec. 31, 2013, and entitled “SEPARATION OF ELECTROLYTES”; U.S. Publication No. US-2010-0291442-A1 published on Nov. 18, 2010, filed as U.S. application Ser. No. 12/682,011 on Jul. 30, 2010, patented as U.S. Pat. No. 8,871,387 on Oct. 28, 2014, and entitled “PRIMER FOR BATTERY ELECTRODE”; U.S. Publication No. US-2009-0200986-A1 published on Aug. 13, 2009, filed as U.S. application Ser. No. 12/069,335 on Feb. 8, 2008, patented as U.S. Pat. No. 8,264,205 on Sep. 11, 2012, and entitled “CIRCUIT FOR CHARGE AND/OR DISCHARGE PROTECTION IN AN ENERGY-STORAGE DEVICE”; U.S. Publication No. US-2007-0224502-A1 published on Sep. 27, 2007, filed as U.S. application Ser. No. 11/400,025 on Apr. 6, 2006, patented as U.S. Pat. No. 7,771,870 on Aug. 10, 2010, and entitled “ELECTRODE PROTECTION IN BOTH AQUEOUS AND NON-AQUEOUS ELECTROCHEMICAL CELLS, INCLUDING RECHARGEABLE LITHIUM BATTERIES”; U.S. Publication No. US-2008-0318128-A1 published on Dec. 25, 2008, filed as U.S. application Ser. No. 11/821,576 on Jun. 22, 2007, and entitled “LITHIUM ALLOY/SULFUR BATTERIES”; U.S. Publication No. US-2002-0055040-A1 published on May 9, 2002, filed as U.S. application Ser. No. 09/795,915 on Feb. 27, 2001, patented as U.S. Pat. No. 7,939,198 on May 10, 2011, and entitled “NOVEL COMPOSITE CATHODES, ELECTROCHEMICAL CELLS COMPRISING NOVEL COMPOSITE CATHODES, AND PROCESSES FOR FABRICATING SAME”; U.S. Publication No. US-2006-0238203-A1 published on Oct. 26, 2006, filed as U.S. application Ser. No. 11/111,262 on Apr. 20, 2005, patented as U.S. Pat. No. 7,688,075 on Mar. 30, 2010, and entitled “LITHIUM SULFUR RECHARGEABLE BATTERY FUEL GAUGE SYSTEMS AND METHODS”; U.S. Publication No. US-2008-0187663-A1 published on Aug. 7, 2008, filed as U.S. application Ser. No. 11/728,197 on Mar. 23, 2007, patented as U.S. Pat. No. 8,084,102 on Dec. 27, 2011, and entitled “METHODS FOR CO-FLASH EVAPORATION OF POLYMERIZABLE MONOMERS AND NON-POLYMERIZABLE CARRIER SOLVENT/SALT MIXTURES/SOLUTIONS”; U.S. Publication No. US-2011-0006738-A1 published on Jan. 13, 2011, filed as U.S. application Ser. No. 12/679,371 on Sep. 23, 2010, and entitled “ELECTROLYTE ADDITIVES FOR LITHIUM BATTERIES AND RELATED METHODS”; U.S. Publication No. US-2011-0008531-A1 published on Jan. 13, 2011, filed as U.S. application Ser. No. 12/811,576 on Sep. 23, 2010, patented as U.S. Pat. No. 9,034,421 on May 19, 2015, and entitled “METHODS OF FORMING ELECTRODES COMPRISING SULFUR AND POROUS MATERIAL COMPRISING CARBON”; U.S. Publication No. US-2010-0035128-A1 published on Feb. 11, 2010, filed as U.S. application Ser. No. 12/535,328 on Aug. 4, 2009, patented as U.S. Pat. No. 9,105,938 on Aug. 11, 2015, and entitled “APPLICATION OF FORCE IN ELECTROCHEMICAL CELLS”; U.S. Publication No. US-2011-0165471-A9 published on Jul. 15, 2011, filed as U.S. application Ser. No. 12/180,379 on Jul. 25, 2008, and entitled “PROTECTION OF ANODES FOR ELECTROCHEMICAL CELLS”; U.S. Publication No. US-2006-0222954-A1 published on Oct. 5, 2006, filed as U.S. application Ser. No. 11/452,445 on Jun. 13, 2006, patented as U.S. Pat. No. 8,415,054 on Apr. 9, 2013, and entitled “LITHIUM ANODES FOR ELECTROCHEMICAL CELLS”; U.S. Publication No. US-2010-0239914-A1 published on Sep. 23, 2010, filed as U.S. application Ser. No. 12/727,862 on Mar. 19, 2010, and entitled “CATHODE FOR LITHIUM BATTERY”; U.S. Publication No. US-2010-0294049-A1 published on Nov. 25, 2010, filed as U.S. application Ser. No. 12/471,095 on May 22, 2009, patented as U.S. Pat. No. 8,087,309 on Jan. 3, 2012, and entitled “HERMETIC SAMPLE HOLDER AND METHOD FOR PERFORMING MICROANALYSIS UNDER CONTROLLED ATMOSPHERE ENVIRONMENT”; U.S. Publication No. US-2011-0076560-A1 published on Mar. 31, 2011, filed as U.S. application Ser. No. 12/862,581 on Aug. 24, 2010, and entitled “ELECTROCHEMICAL CELLS COMPRISING POROUS STRUCTURES COMPRISING SULFUR”; U.S. Publication No. US-2011-0068001-A1 published on Mar. 24, 2011, filed as U.S. application Ser. No. 12/862,513 on Aug. 24, 2010, and entitled “RELEASE SYSTEM FOR ELECTROCHEMICAL CELLS”; U.S. Publication No. US-2012-0048729-A1 published on Mar. 1, 2012, filed as U.S. application Ser. No. 13/216,559 on Aug. 24, 2011, and entitled “ELECTRICALLY NON-CONDUCTIVE MATERIALS FOR ELECTROCHEMICAL CELLS”; U.S. Publication No. US-2011-0177398-A1 published on Jul. 21, 2011, filed as U.S. application Ser. No. 12/862,528 on Aug. 24, 2010, patented as U.S. Pat. No. 10,629,947 on Apr. 21, 2020, and entitled “ELECTROCHEMICAL CELL”; U.S. Publication No. US-2011-0070494-A1 published on Mar. 24, 2011, filed as U.S. application Ser. No. 12/862,563 on Aug. 24, 2010, and entitled “ELECTROCHEMICAL CELLS COMPRISING POROUS STRUCTURES COMPRISING SULFUR”; U.S. Publication No. US-2011-0070491-A1 published on Mar. 24, 2011, filed as U.S. application Ser. No. 12/862,551 on Aug. 24, 2010, and entitled “ELECTROCHEMICAL CELLS COMPRISING POROUS STRUCTURES COMPRISING SULFUR”; U.S. Publication No. US-2011-0059361-A1 published on Mar. 10, 2011, filed as U.S. application Ser. No. 12/862,576 on Aug. 24, 2010, patented as U.S. Pat. No. 9,005,809 on Apr. 14, 2015, and entitled “ELECTROCHEMICAL CELLS COMPRISING POROUS STRUCTURES COMPRISING SULFUR”; U.S. Publication No. US-2012-0052339-A1 published on Mar. 1, 2012, filed as U.S. application Ser. No. 13/216,579 on Aug. 24, 2011, and entitled “ELECTROLYTE MATERIALS FOR USE IN ELECTROCHEMICAL CELLS”; U.S. Publication No. US-2012-0070746-A1 published on Mar. 22, 2012, filed as U.S. application Ser. No. 13/240,113 on Sep. 22, 2011, and entitled “LOW ELECTROLYTE ELECTROCHEMICAL CELLS”; U.S. Publication No. US-2011-0206992-A1 published on Aug. 25, 2011, filed as U.S. application Ser. No. 13/033,419 on Feb. 23, 2011, and entitled “POROUS STRUCTURES FOR ENERGY STORAGE DEVICES”; U.S. Publication No. US-2012-0082872-A1 published on Apr. 5, 2012, filed as U.S. application Ser. No. 13/249,605 on Sep. 30, 2011, and entitled “ADDITIVE FOR ELECTROLYTES”; U.S. Publication No. US-2012-0082901-A1 published on Apr. 5, 2012, filed as U.S. application Ser. No. 13/249,632 on Sep. 30, 2011, and entitled “LITHIUM-BASED ANODE WITH IONIC LIQUID POLYMER GEL”; U.S. Publication No. US-2013-0164635-A1 published on Jun. 27, 2013, filed as U.S. application Ser. No. 13/700,696 on Mar. 6, 2013, patented as U.S. Pat. No. 9,577,243 on Feb. 21 2017, and entitled “USE OF EXPANDED GRAPHITE IN LITHIUM/SULPHUR BATTERIES”; U.S. Publication No. US-2013-0017441-A1 published on Jan. 17, 2013, filed as U.S. application Ser. No. 13/524,662 on Jun. 15, 2012, patented as U.S. Pat. No. 9,548,492 on Jan. 17, 2017, and entitled “PLATING TECHNIQUE FOR ELECTRODE”; U.S. Publication No. US-2013-0224601-A1 published on Aug. 29, 2013, filed as U.S. application Ser. No. 13/766,862 on Feb. 14, 2013, patented as U.S. Pat. No. 9,077,041 on Jul. 7, 2015, and entitled “ELECTRODE STRUCTURE FOR ELECTROCHEMICAL CELL”; U.S. Publication No. US-2013-0252103-A1 published on Sep. 26, 2013, filed as U.S. application Ser. No. 13/789,783 on Mar. 8, 2013, patented as U.S. Pat. No. 9,214,678 on Dec. 15, 2015, and entitled “POROUS SUPPORT STRUCTURES, ELECTRODES CONTAINING SAME, AND ASSOCIATED METHODS”; U.S. Publication No. US-2015-0287998-A1 published on Oct. 8, 2015, filed as U.S. Application No. Ser. No. 14/743,304 on Jun. 18, 2015, patented as U.S. Pat. No. 9,577,267 on Feb. 21, 2017, and entitled “ELECTRODE STRUCTURE AND METHOD FOR MAKING SAME”; U.S. Publication No. US-2013-0095380-A1 published on Apr. 18, 2013, filed as U.S. application Ser. No. 13/644,933 on Oct. 4, 2012, patented as U.S. Pat. No. 8,936,870 on Jan. 20, 2015, and entitled “ELECTRODE STRUCTURE AND METHOD FOR MAKING THE SAME”; U.S. Publication No. US-2012-0052397-A1 published on Mar. 1, 2012, filed as U.S. application Ser. No. 13/216,538 on Aug. 24, 2011, patented as U.S. Pat. No. 9,853,287 on Dec. 26, 2017, and entitled “ELECTROLYTE MATERIALS FOR USE IN ELECTROCHEMICAL CELLS”; U.S. Publication No. US-2014-0123477-A1 published on May 8, 2014, filed as U.S. application Ser. No. 14/069,698 on Nov. 1, 2013, patented as U.S. Pat. No. 9,005,311 on Apr. 14, 2015, and entitled “ELECTRODE ACTIVE SURFACE PRETREATMENT”; U.S. Publication No. US-2014-0193723-A1 published on Jul. 10, 2014, filed as U.S. application Ser. No. 14/150,156 on Jan. 8, 2014, patented as U.S. Pat. No. 9,559,348 on Jan. 31, 2017, and entitled “CONDUCTIVITY CONTROL IN ELECTROCHEMICAL CELLS”; U.S. Publication No. US-2014-0255780-A1 published on Sep. 11, 2014, filed as U.S. application Ser. No. 14/197,782 on Mar. 5, 2014, patented as U.S. Pat. No. 9,490,478 on Nov. 8, 2016, and entitled “ELECTROCHEMICAL CELLS COMPRISING FIBRIL MATERIALS”; U.S. Publication No. US-2014-0272594-A1 published on Sep. 18 2014, filed as U.S. application Ser. No. 13/833,377 on Mar. 15, 2013, and entitled “PROTECTIVE STRUCTURES FOR ELECTRODES”; U.S. Publication No. US-2014-0272597-A1 published on Sep. 18, 2014, filed as U.S. application Ser. No. 14/209,274 on Mar. 13, 2014, patented as U.S. Pat. No. 9,728,768 on Aug. 8, 2017, and entitled “PROTECTED ELECTRODE STRUCTURES AND METHODS”; U.S. Publication No. US-2015-0280277-A1 published on Oct. 1, 2015, filed as U.S. application Ser. No. 14/668,102 on Mar. 25, 2015, patented as U.S. Pat. No. 9,755,268 on Sep. 5, 2017, and entitled “GEL ELECTROLYTES AND ELECTRODES”; U.S. Publication No. US-2015-0180037-A1 published on Jun. 25, 2015, filed as U.S. application Ser. No. 14/576,570 on Dec. 19, 2014, patented as U.S. Pat. No. 10,020,512 on Jul. 10, 2018, and entitled “POLYMER FOR USE AS PROTECTIVE LAYERS AND OTHER COMPONENTS IN ELECTROCHEMICAL CELLS”; U.S. Publication No. US-2015-0349310-A1 published on Dec. 3, 2015, filed as U.S. application Ser. No. 14/723,132 on May 27, 2015, patented as U.S. Pat. No. 9,735,411 on Aug. 15, 2017, and entitled “POLYMER FOR USE AS PROTECTIVE LAYERS AND OTHER COMPONENTS IN ELECTROCHEMICAL CELLS”; U.S. Publication No. US-2014-0272595-A1 published on Sep. 18, 2014, filed as U.S. application Ser. No. 14/203,802 on Mar. 11, 2014, and entitled “COMPOSITIONS FOR USE AS PROTECTIVE LAYERS AND OTHER COMPONENTS IN ELECTROCHEMICAL CELLS”; U.S. Publication No. US-2019-0006699-A1 published on Jan. 3, 2019, filed as U.S. application Ser. No. 15/727,438 on Oct. 6, 2017, and entitled “PRESSURE AND/OR TEMPERATURE MANAGEMENT IN ELECTROCHEMICAL SYSTEMS”; U.S. Publication No. US-2014-0193713-A1 published on Jul. 10, 2014, filed as U.S. application Ser. No. 14/150,196 on Jan. 8, 2014, patented as U.S. Pat. No. 9,531,009 on Dec. 27, 2016, and entitled “PASSIVATION OF ELECTRODES IN ELECTROCHEMICAL CELLS”; U.S. Publication No. US-2014-0127577-A1 published on May 8, 2014, filed as U.S. application Ser. No. 14/068,333 on Oct. 31, 2013, patented as U.S. Pat. No. 10,243,202 on Mar. 26, 2019, and entitled “POLYMERS FOR USE AS PROTECTIVE LAYERS AND OTHER COMPONENTS IN ELECTROCHEMICAL CELLS”; U.S. Publication No. US-2015-0318539-A1 published on Nov. 5, 2015, filed as U.S. application Ser. No. 14/700,258 on Apr. 30, 2015, patented as U.S. Pat. No. 9,711,784 on Jul. 18, 2017, and entitled “ELECTRODE FABRICATION METHODS AND ASSOCIATED SYSTEMS AND ARTICLES”; U.S. Publication No. US-2014-0272565-A1 published on Sep. 18, 2014, filed as U.S. application Ser. No. 14/209,396 on Mar. 13, 2014, patented as U.S. Pat. No. 10,862,105 on Dec. 8, 2020 and entitled “PROTECTED ELECTRODE STRUCTURES”; U.S. Publication No. US-2015-0010804-A1 published on Jan. 8, 2015, filed as U.S. application Ser. No. 14/323,269 on Jul. 3, 2014, patented as U.S. Pat. No. 9,994,959 on Jun. 12, 2018, and entitled “CERAMIC/POLYMER MATRIX FOR ELECTRODE PROTECTION IN ELECTROCHEMICAL CELLS, INCLUDING RECHARGEABLE LITHIUM BATTERIES”; U.S. Publication No. US-2015-0162586-A1 published on Jun. 11, 2015, filed as U.S. application Ser. No. 14/561,305 on Dec. 5, 2014, and entitled “NEW SEPARATOR”; U.S. Publication No. US-2015-0044517-A1 published on Feb. 12, 2015, filed as U.S. application Ser. No. 14/455,230 on Aug. 8, 2014, patented as U.S. Pat. No. 10,020,479 on Jul. 10, 2018, and entitled “SELF-HEALING ELECTRODE PROTECTION IN ELECTROCHEMICAL CELLS”; U.S. Publication No. US-2015-0236322-A1 published on Aug. 20, 2015, filed as U.S. application Ser. No. 14/184,037 on Feb. 19, 2014, patented as U.S. Pat. No. 10,490,796 on Nov. 26, 2019, and entitled “ELECTRODE PROTECTION USING ELECTROLYTE-INHIBITING ION CONDUCTOR”; U.S. Publication No. US-2015-0236320-A1 published on Aug. 20, 2015, filed as U.S. application Ser. No. 14/624,641 on Feb. 18, 2015, patented as U.S. Pat. No. 9,653,750 on May 16, 2017, and entitled “ELECTRODE PROTECTION USING A COMPOSITE COMPRISING AN ELECTROLYTE-INHIBITING ION CONDUCTOR”; U.S. Publication No. US-2016-0118638-A1 published on Apr. 28, 2016, filed as U.S. application Ser. No. 14/921,381 on Oct. 23, 2015, and entitled “COMPOSITIONS FOR USE AS PROTECTIVE LAYERS AND OTHER COMPONENTS IN ELECTROCHEMICAL CELLS”; U.S. Publication No. US-2016-0118651-A1 published on Apr. 28, 2016, filed as U.S. application Ser. No. 14/918,672 on Oct. 21, 2015, and entitled “ION-CONDUCTIVE COMPOSITE FOR ELECTROCHEMICAL CELLS”; U.S. Publication No. US-2016-0072132-A1 published on Mar. 10, 2016, filed as U.S. application Ser. No. 14/848,659 on Sep. 9, 2015, patented as U.S. Pat. No. 11,038,178 on Jun. 15, 2021 and entitled “PROTECTIVE LAYERS IN LITHIUM-ION ELECTROCHEMICAL CELLS AND ASSOCIATED ELECTRODES AND METHODS”; U.S. Publication No. US-2018-0138542-A1 published on May 17, 2018, filed as U.S. application Ser. No. 15/567,534 on Oct. 18, 2017, patented as U.S. Pat. No. 10,847,833 on Nov. 24, 2020 and entitled “GLASS-CERAMIC ELECTROLYTES FOR LITHIUM-SULFUR BATTERIES”; U.S. Publication No. US-2016-0344067-A1 published on Nov. 24, 2016, filed as U.S. application Ser. No. 15/160,191 on May 20, 2016, patented as U.S. Pat. No. 10,461,372 on Oct. 29, 2019, and entitled “PROTECTIVE LAYERS FOR ELECTROCHEMICAL CELLS”; U.S. Publication No. US-2020-0099108-A1 published on Mar. 26, 2020, filed as U.S. application Ser. No. 16/587,939 on Sep. 30, 2019, and entitled “PROTECTIVE LAYERS FOR ELECTROCHEMICAL CELLS”; U.S. Publication No. US-2017-0141385-A1 published on May 18, 2017, filed as U.S. application Ser. No. 15/343,890 on Nov. 4, 2016, and entitled “LAYER COMPOSITE AND ELECTRODE HAVING A SMOOTH SURFACE, AND ASSOCIATED METHODS”; U.S. Publication No. US-2017-0141442-A1 published on May 18, 2017, filed as U.S. application Ser. No. 15/349,140 on Nov. 11, 2016, and entitled “ADDITIVES FOR ELECTROCHEMICAL CELLS”; patented as U.S. patent Ser. No. 10/320,031 on Jun. 11, 2019, and entitled “ADDITIVES FOR ELECTROCHEMICAL CELLS”; U.S. Publication No. US-2017-0149086-A1 published on May 25, 2017, filed as U.S. application Ser. No. 15/343,635 on Nov. 4, 2016, patented as U.S. Pat. No. 9,825,328 on Nov. 21, 2017, and entitled “IONICALLY CONDUCTIVE COMPOUNDS AND RELATED USES”; U.S. Publication No. US-2018-0337406-A1 published on Nov. 22, 2018, filed as U.S. application Ser. No. 15/983,352 on May 18, 2018, patented as U.S. Pat. No. 10,868,306 on Dec. 15, 2020 and entitled “PASSIVATING AGENTS FOR ELECTROCHEMICAL CELLS”; U.S. Publication No. US-2018-0261820-A1 published on Sep. 13, 2018, filed as U.S. application Ser. No. 15/916,588 on Mar. 9, 2018, patented as U.S. Pat. No. 11,024,923 on Jun. 1, 2021 and entitled “ELECTROCHEMICAL CELLS COMPRISING SHORT-CIRCUIT RESISTANT ELECTRONICALLY INSULATING REGIONS”; U.S. Publication No. US-2020-0243824-A1 published on Jul. 30, 2020, filed as U.S. application Ser. No. 16/098,654 on Nov. 2, 2018, patented as U.S. Pat. No. 10,991,925 on Apr. 27, 2021 and entitled “COATINGS FOR COMPONENTS OF ELECTROCHEMICAL CELLS”; U.S. Publication No. US-2018-0351158-A1 published on Dec. 6, 2018, filed as U.S. application Ser. No. 15/983,363 on May 18, 2018, patented as U.S. Pat. No. 10,944,094 on Mar. 9, 2021 and entitled “PASSIVATING AGENTS FOR ELECTROCHEMICAL CELLS”; U.S. Publication No. US-2018-0277850-A1 published on Sep. 27, 2018, filed as U.S. application Ser. No. 15/923,342 on Mar. 16, 2018, and patented as U.S. Pat. No. 10,720,648 on Jul. 21, 2020, and entitled “ELECTRODE EDGE PROTECTION IN ELECTROCHEMICAL CELLS”; U.S. Publication No. US-2018-0358651-A1 published on Dec. 13, 2018, filed as U.S. application Ser. No. 16/002,097 on Jun. 7, 2018, and patented as U.S. Pat. No. 10,608,278 on Mar. 31, 2020, and entitled “IN SITU CURRENT COLLECTOR”; U.S. Publication No. US-2017-0338475-A1 published on Nov. 23, 2017, filed as U.S. application Ser. No. 15/599,595 on May 19, 2017, patented as U.S. Pat. No. 10,879,527 on Dec. 29, 2020, and entitled “PROTECTIVE LAYERS FOR ELECTRODES AND ELECTROCHEMICAL CELLS”; U.S. Publication No. US-2019-0088958-A1 published on Mar. 21, 2019, filed as U.S. application Ser. No. 16/124,384 on Sep. 7, 2018, and entitled “PROTECTIVE MEMBRANE FOR ELECTROCHEMICAL CELLS”; U.S. Publication No. US-2019-0348672-A1 published on Nov. 14, 2019, filed as U.S. application Ser. No. 16/470,708 on Jun. 18, 2019, and entitled “PROTECTIVE LAYERS COMPRISING METALS FOR ELECTROCHEMICAL CELLS”; U.S. Publication No. US-2017-0200975-A1 published Jul. 13, 2017, filed as U.S. application Ser. No. 15/429,439 on Feb. 10, 2017, and patented as U.S. Pat. No. 10,050,308 on Aug. 14, 2018, and entitled “LITHIUM-ION ELECTROCHEMICAL CELL, COMPONENTS THEREOF, AND METHODS OF MAKING AND USING SAME”; U.S. Publication No. US-2018-0351148-A1 published Dec. 6, 2018, filed as U.S. application Ser. No. 15/988,182 on May 24, 2018, and entitled “IONICALLY CONDUCTIVE COMPOUNDS AND RELATED USES”; U.S. Publication No. US-2018-0254516-A1 published Sep. 6, 2018, filed as U.S. application Ser. No. 15/765,362 on Apr. 2, 2018, and entitled “NON-AQUEOUS ELECTROLYTES FOR HIGH ENERGY LITHIUM-ION BATTERIES”; U.S. Publication No. US-2020-0044460-A1 published Feb. 6, 2020, filed as U.S. Application No. 16,527,903 on Jul. 31, 2019, and entitled “MULTIPLEXED CHARGE DISCHARGE BATTERY MANAGEMENT SYSTEM”; U.S. Publication No. US-2020-0220146-A1 published Jul. 9, 2020, filed as U.S. application Ser. No. 16/724,586 on Dec. 23, 2019, and entitled “ISOLATABLE ELECTRODES AND ASSOCIATED ARTICLES AND METHODS”; U.S. Publication No. US-2020-0220149-A1 published Jul. 9, 2020, filed as U.S. application Ser. No. 16/724,596 on Dec. 23, 2019, and entitled “ELECTRODES, HEATERS, SENSORS, AND ASSOCIATED ARTICLES AND METHODS”; U.S. Publication No. US-2020-0220197-A1 published Jul. 9, 2020, filed as U.S. application Ser. No. 16/724,612 on Dec. 23, 2019, and entitled “FOLDED ELECTROCHEMICAL DEVICES AND ASSOCIATED METHODS AND SYSTEMS”, U.S. Publication No. US-2020-0373578-A1 published Nov. 26, 2020, filed as U.S. application Ser. No. 16/879,861 on May 21, 2020, and entitled “ELECTROCHEMICAL DEVICES INCLUDING POROUS LAYERS”, U.S. Publication No. US-2020-0373551-A1 published Nov. 26, 2020, filed as U.S. application Ser. No. 16/879,839 on May 21, 2020, and entitled “ELECTRICALLY COUPLED ELECTRODES, AND ASSOCIATED ARTICLES AND METHODS”, U.S. Publication No. US-2020-0395585-A1 published Dec. 17, 2020, filed as U.S. application Ser. No. 16/057,050 on Aug. 7, 2018, and entitled “LITHIUM-COATED SEPARATORS AND ELECTROCHEMICAL CELLS COMPRISING THE SAME”, U.S. Publication No. US-2021-0057753-A1 published Feb. 25, 2021, filed as U.S. application Ser. No. 16/994,006 on Aug. 14, 2020, and entitled “ELECTROCHEMICAL CELLS AND COMPONENTS COMPRISING THIOL GROUP-CONTAINING SPECIES”, U.S. Publication No. US-2021-0135297-A1 published on May 6, 2021, filed as U.S. application Ser. No. 16/670,905 on Oct. 31, 2019, and entitled SYSTEM AND METHOD FOR OPERATING A RECHARGEABLE ELECTROCHEMICAL CELL OR BATTERY″, U.S. Publication No. US-2021-0138673-A1 published on May 13, 2021, filed as U.S. application Ser. No. 17/089,092 on Nov. 4, 2020, and entitled “ELECTRODE CUTTING INSTRUMENT”, U.S. Publication No. US-2021-0135294-A1 published on May 6, 2021, filed as U.S. application Ser. No. 16/670,933 on Oct. 31, 2019, patented as U.S. Pat. No. 11,056,728 on Jul. 6, 2021 and entitled “SYSTEM AND METHOD FOR OPERATING A RECHARGEABLE ELECTROCHEMICAL CELL OR BATTERY”; U.S. Publication Ser. No. 16/952,177 on Nov. 19, 2020, and entitled “BATTERIES, AND ASSOCIATED SYSTEMS AND METHODS”; U.S. Publication No. US-2021-0151830-A1 published on May 20, 2021, filed as U.S. application Ser. No. 16/952,235 on Nov. 19, 2020, and entitled “BATTERIES WITH COMPONENTS INCLUDING CARBON FIBER, AND ASSOCIATED SYSTEMS AND METHODS”; U.S. Publication No. US-2021-0151817-A1 published on May 20, 2021, filed as U.S. application Ser. No. 16/952,228 on Nov. 19, 2020, and entitled “BATTERY ALIGNMENT, AND ASSOCIATED SYSTEMS AND METHODS”; U.S. Publication No. US-2021-0151841-A1 published on May 20, 2021, filed as U.S. application Ser. No. 16/952,240 on Nov. 19, 2020, and entitled “SYSTEMS AND METHODS FOR APPLYING AND MAINTAINING COMPRESSION PRESSURE ON ELECTROCHEMICAL CELLS”; U.S. Publication No. US-2021-0151816-A1 published on May 20, 2021, filed as U.S. application Ser. No. 16/952,223 on Nov. 19, 2020, and entitled “THERMALLY INSULATING COMPRESSIBLE COMPONENTS FOR BATTERY PACKS”; U.S. Publication No. US-2021-0151840-A1 published on May 20, 2021, filed as U.S. application Ser. No. 16/952,187 on Nov. 19, 2020, and entitled “COMPRESSION SYSTEMS FOR BATTERIES”; U.S. Publication No. US-2021-0193984-A1 published on Jun. 24, 2021, filed as U.S. application Ser. No. 17/125,124 on Dec. 17, 2020, and entitled “SYSTEMS AND METHODS FOR FABRICATING LITHIUM METAL ELECTRODES”; U.S. Publication No. US-2021-0193985-A1 published on Jun. 24, 2021, filed as U.S. application Ser. No. 17/125,110 on Dec. 17, 2020, and entitled “LITHIUM METAL ELECTRODES AND METHODS”; U.S. Publication No. US-2021-0193996-A1 published on Jun. 24, 2021, filed as U.S. application Ser. No. 17/125,070 on Dec. 17, 2020, and entitled “LITHIUM METAL ELECTRODES”; U.S.

Publication No. US-2021-0194069-A1 published on Jun. 24, 2021, filed as U.S. application Ser. No. 17/126,390 on Dec. 18, 2020, and entitled “SYSTEMS AND METHODS FOR PROVIDING, ASSEMBLING, AND MANAGING INTEGRATED POWER BUS FOR RECHARGEABLE ELECTROCHEMICAL CELL OR BATTERY”.

The following examples are intended to illustrate certain embodiments of the present invention, but do not exemplify the full scope of the invention.

### Example 1

The following example shows the improved cycle life performance of the second electrode (i.e., the anode) where at least a portion of the surface of the current collector of the second electrode is coated with magnesium.

Electrochemical cells were fabricated as described. A cathode was constructed by deposition NCM811 on a copper current collector. Lithium metal (0.5 μm) was vapor deposited on a 0.5 mil copper foil current collector to construct the anode. The cathode and the anode were separated by an Entek 9 μm EP separator. For one electrochemical cell, the anode included magnesium deposited on the surface of the current collector. Each electrochemical cell was charged at 30 mA and discharged at 300 mA during the initial formation cycles, followed by charging at 75 mA and discharging at 300 mA for the remaining cycles.

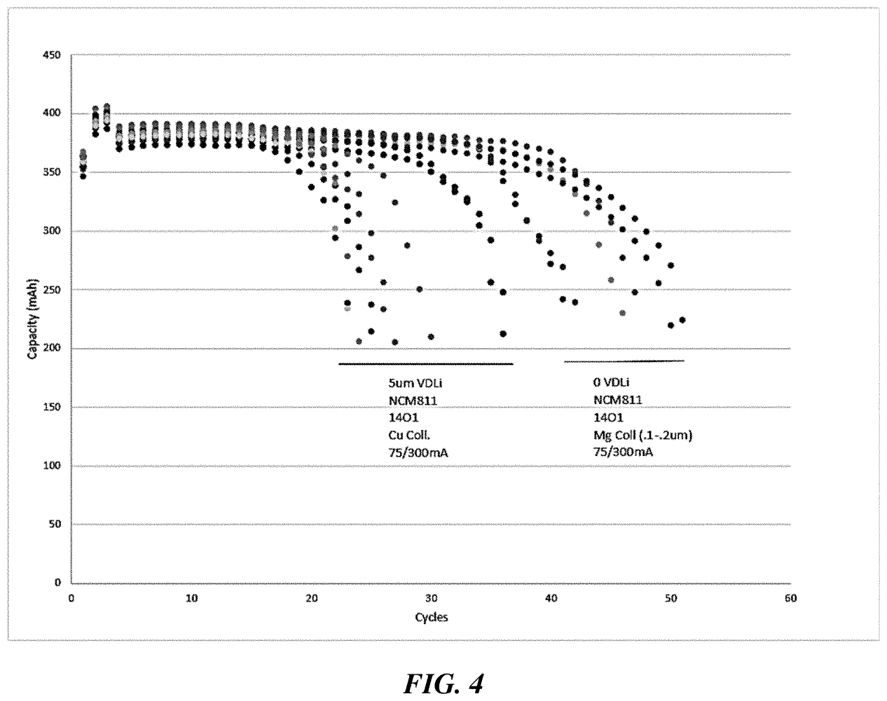

As shown in FIG. 4, the anode comprising a copper collector coated with magnesium exhibited improved cycle life compared to electrochemical cells fabricated without a magnesium-coated current collector. All cells were charged and discharged at the same rate (75 mA charge/300 mA discharge), including the initial formation cycle (30 mA charge/300 mA discharge).

### Example 2

The following example illustrates the effect when elevated temperature when used during the formation cycles.

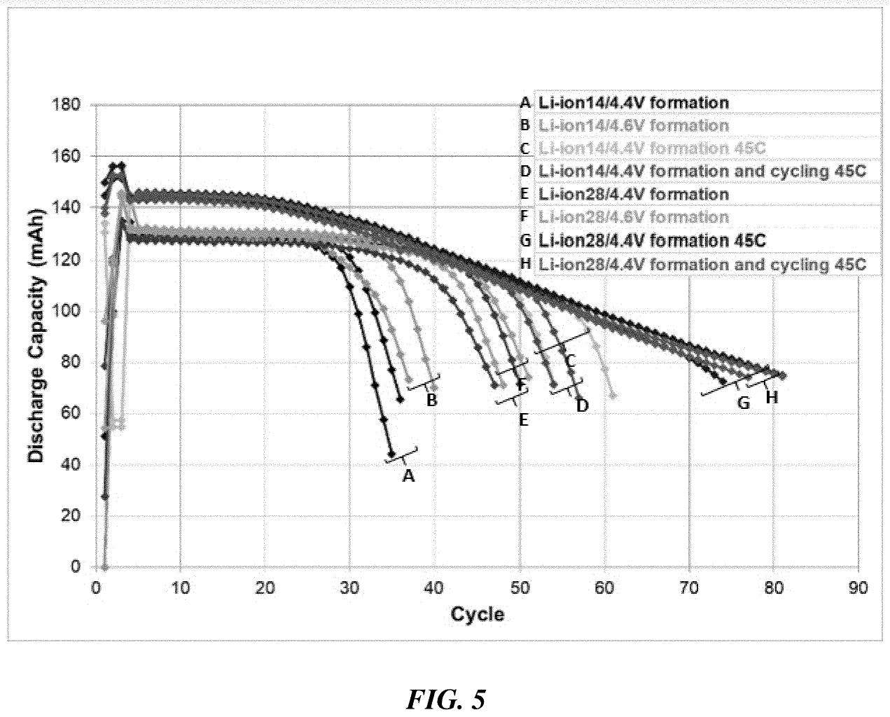

The electrochemical cells used in this example were constructed as described in Example 1, except an elevated temperature was applied during the formation cycles. As shown in FIG. 5, the cells showed a higher cycle performance after increasing the temperature to 45° C. during the initial formation cycles as well as the regular cycles. For this example, a 12 kg/cm² anisotropic pressure was used during the cycling steps, and a copper current collector was used as an anode. In addition, a higher FEC content showed improved cycle life, as evidenced with Lion28 (1:3 FEC/DMC) compared to Lion14 (1:4 FEC/DMC).

### Example 3

The following example demonstrates the effect of applying different amounts of anisotropic pressure on the cycling performance of a cell. The electrochemical cells were prepared as described in Example 1.

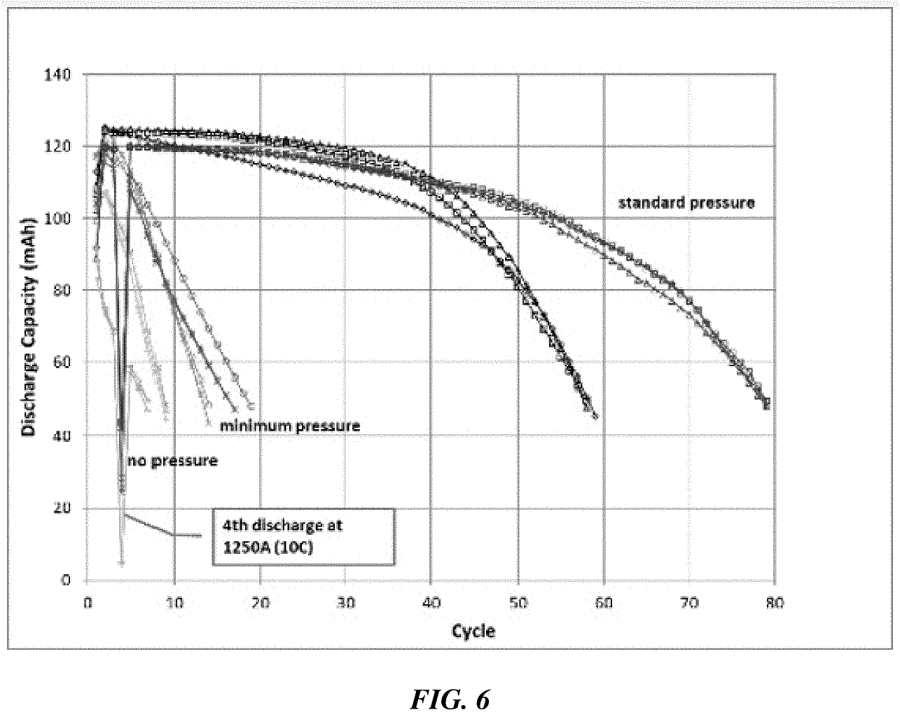

FIG. 6 shows cells with improved cycle life of the cells after applying pressure.

### Example 4

The following example shows the cycling performance of electrochemical cells with varying amounts of cathode active material. The electrochemical cells were prepared as described in Example 1.

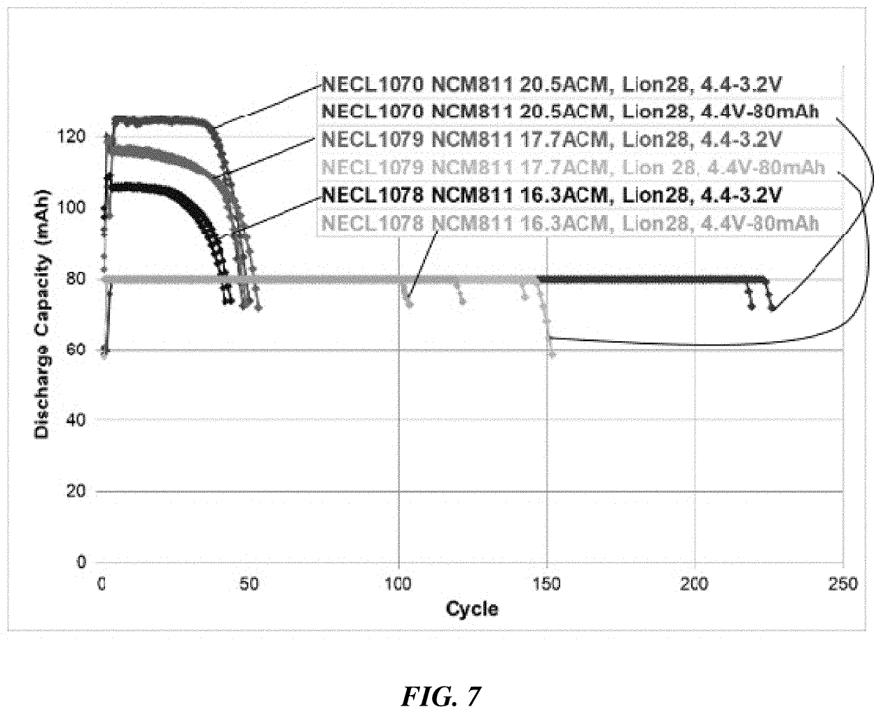

FIG. 7 shows the cells with the highest loading of NCM cathode active material showed an improvement in cycling performance although less Li cycled with each cycle.

### Example 5

The following example shows the effect of varying the applied voltage during the formation cycles. The electrochemical cells were prepared as described in Example 1.

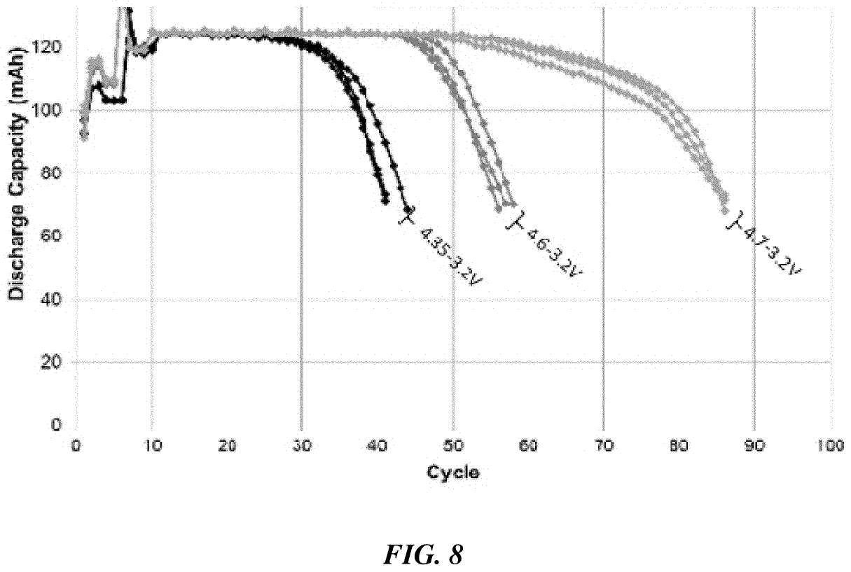

FIG. 8 shows the cycling performance of cells charged/discharged at voltages of 4.35 V-3.2 V, 4.6 V-3.2 V, and 4.7 V-3.2 V. The higher charging of a cell resulted in an improved cycling performance, as exampled from the measurement at 4.7 V in comparison to 4.35 V.

### Example 6

The following example shows the charge/discharge performance of several cathode active materials on electrochemical cell performance.

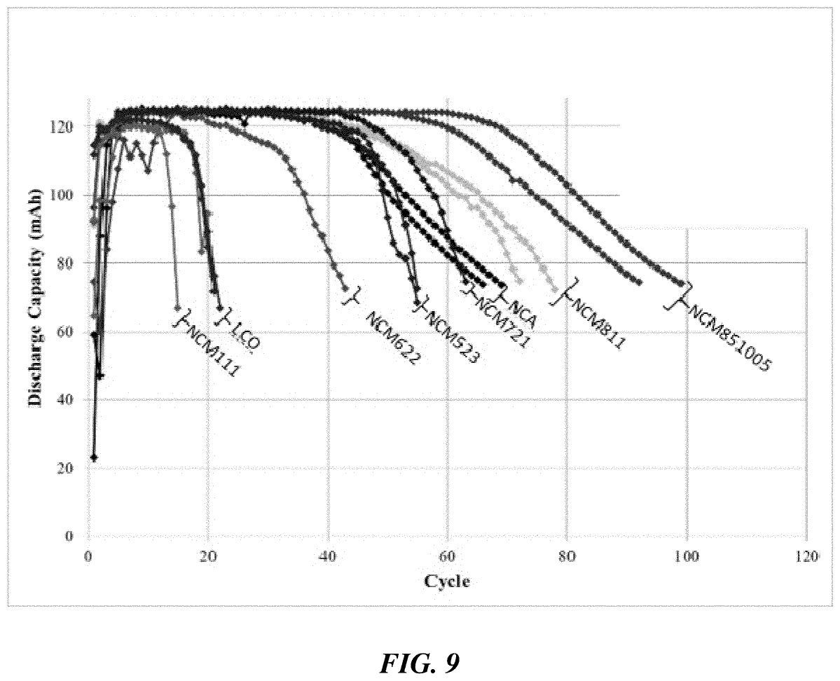

The cathode active materials include NCM, LCO, and NCA with varying ratios of these materials for each electrode. As shown in FIG. 9, NCM851005 showed an improved performance relative to the other cathode active materials upon cycling the electrochemical cell containing this NCM electrode.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of forming a protective layer on an electrode, the method comprising:
in an electrochemical cell comprising a first electrode comprises a lithium intercalation compound having a nickel content of greater than or equal to 70 at % relative to other transition metals in the lithium intercalation compound, performing the steps of:
applying one or more formation cycles to a second electrode, the one or more formation cycles comprising:
charging the second electrode at a first current to a voltage of greater than or equal to 4.4 V, and
discharging the second electrode at a second current to a voltage of less than 4.4 V; and
forming a protective layer on at least a portion of a surface of the second electrode.

2. (canceled)

3. An electrochemical cell, comprising:
a first electrode comprising a lithium intercalation compound having a nickel content of greater than or equal to 70 at % relative to other transition metals in the lithium intercalation compound;
a second electrode comprising a current collector;
a separator between the first electrode and the second electrode; and
a source of lithium between the first electrode and the separator,
wherein an average thickness of lithium between the second electrode and the separator is less than or equal to 30 μm.

4. An electrochemical cell, comprising:
a first electrode comprising a lithium intercalation compound having a nickel content of greater than or equal to 70 at % relative to other transition metals in the lithium intercalation compound;
a second electrode comprising a current collector;
a separator between the first electrode and the second electrode;
a protective layer on at least a portion of a surface of the second electrode, wherein the protective layer comprises a lithium compound, and
wherein the protective layer has an average thickness of less than or equal to 10 μm.

5. The electrochemical cell of claim 2, wherein the protective layer comprises a lithium compound comprising LiO₂, Li₂CO₃, and/or LiF.

6. The method of claim 1, wherein the first electrode comprises a lithium intercalation compound having a nickel content of greater than or equal to 70 at % relative to other transition metals in the lithium intercalation compound.

7. The method of claim 1, wherein charging occurs at a rate of greater than or equal to C/40 and/or less than or equal to 3 C.

8. The method of claim 1, wherein discharging occurs at a rate of greater than or equal to C/40 and/or less than or equal to 10 C.

9. The method of claim 1, wherein charging occurs at a different rate than discharging.

10. The method of claim 1, wherein discharging occurs at a faster rate than charging.

11. The method of claim 1, further comprising apply one or more subsequent cycles, different from the formation cycles, wherein a voltage of the first electrode and/or the second electrode does not exceed 4.4 V.

12. The method of claim 1, further comprising performing greater than or equal to one formation cycle or less than or equal to ten formation cycles.

13. The method of claim 1, wherein the one or more formation cycles occurs on or within the first 10 charge/discharge cycles of the first electrode and/or the second electrode.

14. The method of claim 1, further comprising heating the second electrode to a temperature of greater than or equal to 40° C. during the one or more formation cycles.

15. The electrochemical cell of claim 2, wherein the second electrode comprises a current collector.

16. The electrochemical cell of claim 2, wherein the first electrode and/or the second electrode is free of any lithium.

17. The electrochemical cell of claim 2, wherein the protective layer comprises Mg.

18. The electrochemical cell of claim 2, wherein the protective layer has an average thickness of greater than or equal to 0.1 μm and/or less than or equal to 10 μm.

19. The electrochemical cell of claim 2, further comprising a source of lithium.

20. The electrochemical cell of claim 2, wherein a source of lithium is contained within the first electrode.

21. The electrochemical cell of claim 2, further comprising a liquid electrolyte.

22-39. (canceled)
